(19) United States
(12) Patent Application Publication
(10) Pub. No.: US 2014/0247890 A1
(43) Pub. Date: Sep. 4, 2014

(54) ENCODING DEVICE, ENCODING METHOD, DECODING DEVICE, AND DECODING METHOD

(71) Applicant: Kabushiki Kaisha Toshiba, Minato-ku (JP)

(72) Inventors: Jun YAMAGUCHI, Kawasaki-shi (JP); Tomoya KODAMA, Kawasaki-shi (JP); Akiyuki TANIZAWA, Kawasaki-shi (JP)

(73) Assignee: Kabushiki Kaisha Toshiba, Minato-ku (JP)

(21) Appl. No.: 14/150,063

(22) Filed: Jan. 8, 2014

(30) Foreign Application Priority Data
Mar. 4, 2013 (JP) 2013-041855

(51) Int. Cl. H04N 19/117; H04N 19/137; H04N 19/184; H04N 19/80

(52) U.S. Cl. CPC H04N 19/00066; H04N 19/0089; H04N 19/00145; H04N 19/00309
USPC 375/240.29

(57) ABSTRACT

According to an embodiment, an encoding device includes a first encoder, a filter processor, a difference image generating unit, and a second encoder. The first encoder encodes an input image by a first encoding process to obtain first encoded data. The filter processor filters a first decoded image included in the first encoded data by cutting off a specific frequency band of frequency components to obtain a base image. The difference image generating unit generates a difference image between the input image and the base image. The second encoder encodes the difference image by a second encoding process to obtain second encoded data.

### CROSS-REFERENCE TO RELATED APPLICATIONS

This application is based upon and claims the benefit of priority from Japanese Patent Application No. 2013-041855, filed on Mar. 4, 2013; the entire contents of which are incorporated herein by reference.

### FIELD

Embodiments described herein relate generally to an encoding device, an encoding method, a decoding device, and a decoding method.

### BACKGROUND

Standardization activities have recently been in progress for standards on scalable coding achieving scalability in various aspects such as image quality and resolution as extended standards of a video coding technique “High Efficiency Video Coding” (ITU-T REC. H.265 and ISO/IEC 23008-2, hereinafter abbreviated as HEVC) aiming at doubling the coding efficiency of H.264/AVC (hereinafter abbreviated as H.264) that is an international standard of video coding recommended as ITU-T REC. H.264 and ISO/IEC 14496-10.

In related art, a known technology of scalable coding includes outputting first encoded data generated by performing a first encoding process on an original image (input image) and second encoded data generated by performing a second encoding process on a difference image between the original image and a base image that is a low-quality image obtained by decoding the first encoded data to a decoder side, and generating a high-quality composite image based on the base image obtained by decoding the first encoded data and the difference image obtained by decoding the second encoded data at the decoder side.

With the technology of the related art, however, there is a disadvantage that the efficiency of encoding the difference image is low.

### BRIEF DESCRIPTION OF THE DRAWINGS

FIG. 1 is a diagram illustrating an exemplary configuration of a video encoding device according to a first embodiment;

FIG. 2 is a diagram illustrating a detailed exemplary configuration of a first determining unit according to the first embodiment;

FIG. 3 is a conceptual graph illustrating a rate-distortion curve according to an embodiment;

FIG. 4 is a conceptual graph illustrating the relation between cutoff frequency and basic PSNR according to the embodiment;

FIG. 5 is a graph illustrating the relation between the cutoff frequency and improvement from the basic PSNR according to the embodiment;

FIG. 6 is a conceptual graph illustrating the relation between the cutoff frequency and PSNR according to the embodiment;

FIG. 7 is a flowchart illustrating an example of processing performed by the first determining unit according to the embodiment;

FIG. 8 is a diagram illustrating a detailed exemplary configuration of a first determining unit according to a modified example;

FIG. 9 is a conceptual graph illustrating relation information depending on encoding distortion according to a modified example;

FIG. 10 is a flowchart illustrating an example of processing performed by the first determining unit according to a modified example;

FIG. 11 is a diagram illustrating a detailed exemplary configuration of a first determining unit according to a modified example;

FIG. 12 is a diagram illustrating a detailed exemplary configuration of a first determining unit according to a modified example;

FIG. 13 is a diagram illustrating an exemplary configuration of a video decoding device according to a second embodiment;

FIG. 14 is a diagram illustrating an exemplary configuration of a video encoding device according to a third embodiment;

FIG. 15 is a diagram illustrating an exemplary configuration of a video decoding device according to a fourth embodiment;

FIG. 16 is a diagram illustrating an exemplary configuration of a video encoding device according to a fifth embodiment;

FIG. 17 is a diagram illustrating an exemplary configuration of a video decoding device according to a sixth embodiment;

FIG. 18 is a diagram illustrating an exemplary configuration of a video encoding device according to a seventh embodiment;

FIG. 19 is a diagram illustrating an exemplary configuration of a video decoding device according to an eighth embodiment;

FIG. 20 is a diagram illustrating an exemplary configuration of a video encoding device according to a ninth embodiment;

FIG. 21 is a diagram for explaining an example of frame interpolation according to the ninth embodiment;

FIG. 22 is a diagram illustrating an exemplary configuration of a video decoding device according to a tenth embodiment;

FIG. 23 is a diagram illustrating an exemplary configuration of a video encoding device according to an eleventh embodiment; and

FIG. 24 is a diagram illustrating an exemplary configuration of a video decoding device according to a twelfth embodiment.

### DETAILED DESCRIPTION

According to an embodiment, an encoding device includes a first encoder, a filter processor, a difference image generating unit, and a second encoder. The first encoder encodes an input image by a first encoding process to obtain first encoded data. The filter processor filters a first decoded image included in the first encoded data by cutting off a specific frequency band of frequency components to obtain a base image. The difference image generating unit generates a difference image between the input image and the base image. The second encoder encodes the difference image by a second encoding process to obtain second encoded data. The action of “obtaining” herein can be performed by “generating” in the following embodiments.

An outline of the embodiments will be described before describing specific embodiments of an encoding device, an encoding method, a decoding device, and a decoding method according to the present application. With such a configuration as the technology of the related art described above that outputs first encoded data generated by performing a first encoding process on an original image (input image) and second encoded data generated by performing a second encoding process on a difference image between the original image and a base image that is a low-quality image obtained by decoding the first encoded data to a decoder side, encoding distortion caused by the first encoding process is directly superimposed on the difference image. The encoding distortion thus affects the coding efficiency of the second encoding process. In common video coding techniques, encoding combining a technology of reducing spatial redundancy and a technology of reducing temporal redundancy is used. Examples of the encoding techniques include MPEG-2, and H.264 and HEVC.

With the video coding technique such as MPEG-2, and H.264 and HEVC, intra prediction and inter prediction are performed to reduce the spatial redundancy and the temporal redundancy of an image, residual signals generated by the predictions are converted into spatial frequency components and quantized to achieve compression with a controlled balance between the image quality and the bit rate. Typical images such as person images and nature images have characteristics of high spatial correlation and high temporal correlation, and thus, the spatial redundancy is reduced by intra prediction using the spatial correlation and the temporal redundancy is reduced by inter prediction. In the inter prediction, an encoded image is referred to perform motion compensated prediction of a pixel block to be encoded. The spatial frequency component of a residual signal generated by the intra prediction or the inter prediction is quantized. The spatial redundancy can be further reduced by using a quantization matrix with different weights on different frequency components so that the low frequency component having a significant influence on the image quality is protected while the high frequency component having a small influence is removed making use of the fact that the visual characteristics of humans are sensitive to image quality degradation in a low frequency band and insensitive to image quality degradation in a high frequency band.

The encoding distortion in the video coding techniques is indeed quantization errors. Note that errors are caused in transform and inverse transform, which are very small compared to the quantization errors, will therefore be ignored. Since a quantization error is typically an uncorrelated noise, the spatial correlation and the temporal correlation of encoding distortion are both very low. Since the difference image having these characteristics cannot be efficiently encoded by the common video coding techniques, the coding efficiency of the second encoding process is disadvantageously low.

One feature of the embodiments is an improvement in the coding efficiency of the second encoding process on a difference image between a base image and an input image by generating the base image by applying filtering to cut off a specific frequency band of the frequency components of a first decoded image obtained by decoding first encoded data. Embodiments of an encoding device, an encoding method, a decoding device, and a decoding method will be described in detail below with reference to the accompanying drawings.

### First Embodiment

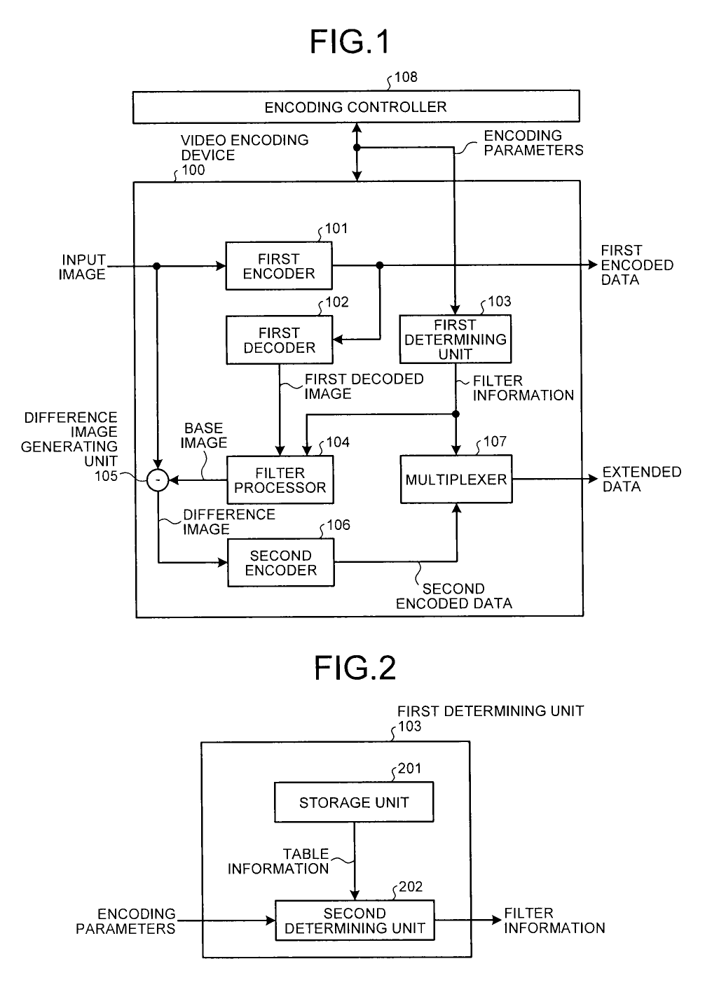

FIG. 1 is a block diagram illustrating the configuration of a video encoding device 100 according to an embodiment, and an encoding controller 108 that externally controls encoding parameters, frame synchronization, and the like of the video encoding device 100. As illustrated in FIG. 1, the video encoding device 100 includes a first encoder 101, a first decoder 102, a first determining unit 103, a filter processor 104, a difference image generating unit 105, a second encoder 106, and a multiplexer 107.

The first encoder 101 performs a first encoding process on an image (hereinafter referred to as an “input image”) that is externally input to generate first encoded data. The first encoder 101 then outputs the generated first encoded data to an associated video decoding device (which will be described in the second embodiment), which is not illustrated, and sends the same to the first decoder 102.

The first decoder 102 performs a first decoding process on the first encoded data received from the first encoder 101 to generate a first decoded image. The first decoder 102 then sends the generated first decoded image to the filter processor 104.

The filter processor 104 performs filtering to cut off a specific frequency band of the frequency components of the first decoded image received from the first decoder 102 to generate a base image. In the present embodiment, the filtering is low-pass filtering passing components with frequencies lower than a cutoff frequency out of the frequency components of the first decoded image received from the first decoder 102. More specifically, the filter processor 104 performs low-pass filtering passing components with frequencies lower than the cutoff frequency indicated by filter information received from the first determining unit 103 out of the frequency components of the first decoded image received from the first decoder 102 to generate a base image. The filter processor 104 then outputs the generated base image to the difference image generating unit 105.

The first determining unit 103 receives encoding parameters from the encoding controller 108 and determines the specific frequency band to be cut off by the filtering. In the present embodiment, the first determining unit 103 determines the aforementioned cutoff frequency on the basis of the encoding parameters received from the encoding controller 108, and sends filter information indicating the determined cutoff frequency to the filter processor 104 and the multiplexer 107. Specific details of the encoding parameters and the first determining unit 103 will be described later.

The difference image generating unit 105 generates a difference image between the input image and the base image. More specifically, the difference image generating unit 105 calculates the difference between the input image and the base image received from the filter processor 104 to generate the difference image. The difference image generating unit 105 then sends the generated difference image to the second encoder 106.

The second encoder 106 performs a second encoding process on the difference image to generate second encoded data. More specifically, the second encoder 106 receives the difference image from the difference image generating unit 105, and performs the second encoding process on the received difference image to generate the second encoded data. The second encoder 106 then sends the generated second encoded data to the multiplexer 107.

The multiplexer 107 multiplexes the filter information received from the first determining unit 103 and the second encoded data received from the second encoder 106 to generate extended data. The multiplexer 107 then outputs the generated extended data to the associated video decoding device, which is not illustrated.

The encoding parameters mentioned above are parameters necessary for encoding such as information on a target bit rate (an index indicating the amount of data that can be sent per unit time), prediction information indicating the method of predictive coding, information on a quantized transform coefficient, and information on quantization. For example, the encoding controller 108 may be provided with an internal memory (not illustrated) in which the encoding parameters are held and may be referred to by the processing blocks (such as the first encoder 101 and the second encoder 106) in decoding a pixel block.

If the target bit rate for encoding the input image is set to 1 Mbps, for example, the first encoder 101 and the second encoder 106 refer to this information to control the value of the quantization parameter and control the generated code amount. If the total bit rate of output from the video encoding device 100 is set to 1 Mbps, for example, information indicating the code amount generated by the first encoder 101 is recorded as an encoding parameter, and can be loaded each time from the encoding controller 108 and used for controlling the code amount generated by the second encoder 106. Control of the code amount is called rate control, and TM5 that is a MPEG-2 reference model is known, for example.

In the present embodiment, the encoding parameters input from the encoding controller 108 includes a bit rate (a target value of the bit rate for the second encoded data) given for the second encoded data, and the first determining unit 103 determines the cutoff frequency on the basis of the bit rate given for the second encoded data. FIG. 2 is a block diagram illustrating a detailed exemplary configuration of the first determining unit 103 according to the present embodiment. As illustrated in FIG. 2, the first determining unit 103 includes a storage unit 201 and a second determining unit 202.

Although details will be described later, the relation between the cutoff frequency and the PSNR indicating the objective image quality of the second decoded image obtained by decoding the second encoded data at each bit rate of the second encoded data is expressed by a parabola (a concave down curve) having a maximum point. The storage unit 201 then stores relation information indicating the relation between the bit rate and a maximum cutoff frequency representing the cutoff frequency corresponding to the maximum point of the parabola (the cutoff frequency at which the PSNR of the second decoded image is maximum). The PSNR is an index indicating how much the image quality of the second decoded image is degraded from the difference image that is the original image, and a larger PSNR represents less degradation in the image quality of the second decoded image, that is, higher objective image quality of the second decoded image. In this example, the PSNR corresponds to “image quality information” in the claims but is not limited thereto.

The second determining unit 202 identifies the maximum cutoff frequency associated with a specified bit rate (in this example, the bit rate of the second encoded data indicated by the encoding parameter received from the encoding controller 108) by using the relation information stored in the storage unit 201, and determines the identified maximum cutoff frequency as the cutoff frequency to be used for filtering by the filter processor 104. Further details of the storage unit 201 and the second determining unit 202 will be described later.

Next, specific details of an encoding method of the video encoding device 100 according to the present embodiment will be described. First, the video encoding device 100 receives an input image externally, and sends the received input image to the first encoder 101.

The first encoder 101 performs the first encoding process on the input image on the basis of encoding parameters input from the encoding controller 108 to generate first encoded data. The first encoder 101 outputs the generated first encoded data to the associated video decoding device, which is not illustrated, and sends the same to the first decoder 102. Note that the first encoding process in the present embodiment is an encoding process performed by an encoder supporting the video coding techniques such as MPEG-2, and H.264 and HEVC, but is not limited thereto.

The first decoder 102 performs a first decoding process on the first encoded data received from the first encoder 101 to generate a first decoded image. The first decoder 102 then sends the generated first decoded image to the first determining unit 103. The first decoding process is a counterpart of the first encoding process performed by the first encoder 101. If the first encoder 101 has a function of locally decoding the generated first encoded data, the first decoder 102 may be skipped and the first decoded image may be output from the first encoder 101. In other words, a configuration in which the first decoder 102 is not provided may be used.

The first determining unit 103 receives a bit rate given for the second encoded data as an encoding parameter to be used in the second encoding process at the second encoder 106 from the encoding controller 108. The first determining unit 103 determines a frequency band to be cut off out of the frequency components of the first decoded image according to this bit rate, and sends filter information indicating the determined frequency band to the filter processor 104 and the multiplexer 107. The method for determining the frequency band to be cut off will be described later in detail. The filter information may contain a filter coefficient itself for cutting off only a specific frequency band out of the frequency components of the first decoded image, or may further contain the number of taps in the filter and a filter shape. Furthermore, information on an index representing the filter coefficient selected from multiple filter coefficients provided in advance may be contained in the filter information as the information indicating the filter coefficient. In this case, the same filter coefficient needs to be held in the associated video decoding device. If one filter coefficient is provided in advance, however, the index representing the filter coefficient need not be sent as the filter information.

The filter processor 104 performs filtering (band-limiting filtering) on the first decoded image received from the first decoder 102 on the basis of the filter information received from the first determining unit 103 to generate a base image. The filter processor 104 then sends the generated base image to the difference image generating unit 105. The filtering performed by the filter processor 104 can be realized by spatial filtering expressed by the following equation (1), for example:

$$g ( x , y ) = {\sum }_{i} {\sum }_{j} h ( x , y ) f ( x - i , y - j ) \qquad ( 1 )$$

In the equation (1), f(x, y) represents a pixel value at coordinates (x, y) of the image input to the filter processor 104, that is, the first decoded image, and g(x, y) represents a pixel value at coordinates (x, y) of the image generated by the filtering, that is, the base image. In addition, h(x, y) represents the filter coefficient. In this example, the coordinates (x, y) are expressed relative to the uppermost-leftmost pixel among pixels constituting an image and arranged in a matrix, where the vertically downward direction is the positive direction of the y-axis and the horizontally rightward direction is the positive direction of the x-axis. The possible values of integers i and j in the equation (1) depend on the horizontal and vertical tap lengths of the filter, respectively. The filter coefficient h(x, y) may be any filter coefficient having a filter characteristic cutting off the frequency band indicated by the filter information, and is preferably a filter coefficient having a filter characteristic that does not emphasize specific frequency components. If the filter characteristic emphasizes specific frequency components out of the frequency components allowed to pass, the specific frequency components out of the frequency components of the first decoded image are emphasized and thus specific frequency components out of the frequency components of the encoding distortion caused by the first encoding process are also emphasized. As a result, the encoding distortion contained in the difference image is also emphasized correspondingly, which lowers the coding efficiency of the second encoding process. In this case, the value of the filter coefficient is a negative value.

Alternatively, the filtering performed by the filter processor 104 can be realized by frequency filtering expressed by the following equation (2), for example:

G(u,v)=F(u,v)H(u,v) (2)

In the equation (2), F(u, v) represents a result of a Fourier transform on the image input to the filter processor 104, that is, the first decoded image, G(u, v) represents an output of the frequency filtering, and H(u, v) represents a frequency filter. In addition, u represents horizontal frequency, and v represents vertical frequency. The value of the frequency filter H(u, v) may be set to 0 if the frequency u and the frequency v are included in the frequency band indicated by the filter information, and the value of the frequency filter H(u, v) may be set to 1 if the frequency u and the frequency v are not included in the frequency band indicated by the filter information. G(u, v) is then inverse Fourier transformed and a pixel value g(x, y) of the base image is generated.

The filtering by the filter processor 104 need not be performed on all of the pixels constituting the first decoded image but may be applied only to specific regions. The units of the regions to which the filtering is applied may be switched among frames, fields, pixel blocks and pixels. In this case, information indicating the regions to which the filtering is applied or information on whether or not to apply the filtering needs to be further contained in the filter information. If the specific region can be uniquely identified according to a specific criterion from the first decoded image or the first encoded data, for example, the information indicating the region need not be contained in the filter information. For example, if the regions are switched for each specific fixed block size, the information indicating the regions need not be contained. Alternatively, for example, if whether or not to perform filtering can be uniquely determined according to a specific criterion from the first decoded image or the first encoded data, the information indicating whether or not to perform the filtering need not be contained in the filter information. If the encoding distortion is estimated and the filtering is applied when the encoding distortion is larger than a specific criterion and the filtering is not applied when the encoding distortion is smaller than the criterion, for example, the information indicating whether or not to perform the filtering need not be contained. In such cases, the associated video decoding device, which is not illustrated, needs to follow the same criteria.

Furthermore, the filtering described above may block different frequency bands for different regions. In this case, information indicating the frequency band to be cut off for each region may be contained in the filter information in addition to the information indicating the regions. For example, if the filtering is switched among four filters, information (two-bit information, for example) indicating which filter is to be applied can be contained in the filter information. If the frequency band to be cut off can be uniquely identified on the basis of a specific criterion from the first decoded image or the first encoded data, for example, the information indicating the frequency band to be cut off need not be contained in the filter information. If the encoding distortion is estimated and the filter is switched according to the size of the encoding distortion, the associated video decoding device needs to follow the same criterion.

In the present embodiment, the filtering by the filter processor 104 is low-pass filtering passing components with frequencies lower than a cutoff frequency (cutting off components with frequencies equal to or higher than the cutoff frequency) out of the frequency components of the first decoded image. More specifically, the filter processor 104 performs low-pass filtering on the first decoded image received from the first decoder 102 to pass only components with frequencies lower than the cutoff frequency (cutting off components with frequencies equal to or higher than the cutoff frequency) indicated by filter information received from the first determining unit 103 out of the frequency components of the first decoded image to generate the base image. In this case, the filter information may contain information indicating a specific cutoff frequency and a low-pass filter. If the filtering by the filter processor 104 is limited to low-pass filtering, the information indicating a low-pass filter need not be contained in the filter information.

Subsequently, the difference image generating unit 105 receives the base image from the filter processor 104, and calculates the difference between the input image and the base image to generate a difference image. The difference image generating unit 105 then sends the generated difference image to the second encoder 106. In the present embodiment, it is assumed that the bit depths of the input image and the base image are expressed in 8 bits. Thus, the pixels constituting the respective images may have integer values ranging from 0 to 255. In this case, as a result of simply calculating the difference between the input image and the base image, the pixels constituting the difference image have values ranging from −255 to 255, which is a 9-bit range including negative values. In the common video coding techniques, however, images constituted by pixels having negative values are not supported as input. The pixels constituting the difference image thus need to be converted so that the difference image will be supported by the second encoder 106 (so that the pixels of the difference image will be within the range of pixel values defined by the encoding method of the second encoder 106). The method for the conversion may be any method, and the conversion may be made by adding a specific offset value to the pixels constituting the difference image and then performing clipping so that the pixels will be within a specific range. For example, if an image having a bit depth of 8 bits is assumed as an input to the second encoder 106, the pixels constituting the difference image can be converted to be in the range from 0 to 255 by calculating the difference by using the following equation (3):

$$Diff ( x , y ) = clip 3 ( Org ( x , y ) - Base ( x , y ) + 128 , 0 , 255 ) \\ clip 3 ( a , b , c ) = \{ \begin{matrix}a ( b \leq a \leq c ) \\ b ( a < b ) \\ c ( < a )\end{matrix} \qquad ( 3 )$$

In the equation (3), Org(x, y) represents a pixel value at coordinates (x, y) of the input image, Base(x, y) represents a pixel value at coordinates (x, y) of the base image, and Diff(x, y) represents a pixel value at coordinates (x, y) of the difference image. In the equation (3), the specific offset value corresponds to 128, and the specific range corresponds to 0 to 255. By the conversion, the difference image can be converted to an image having a bit depth of 8 bits supported by the second encoder 106.

The conversion may cause errors due to clipping unlike the actual difference values, but since the difference image includes the encoding distortion resulting from the first encoding process at the first encoder 101, the variance in the pixels constituting the difference image is typically very small and errors rarely occur.

Alternatively, conversion of the pixels constituting the difference image can be made by using the following equation (4), for example:

Diff(x,y)=(Org(x,y)−Base(x,y)+255)>>1 (4)

In the equation (4), “a>>b” refers to shifting the bits of a by b bits to the right. Thus, in the equation (4), Diff(x, y) represents a result of shifting (Org(x, y)−Base(x, y)+255) by 1 bit to the right. In this manner, the pixel values can be converted by adding a specific offset value (“255” in the equation (4)) to the pixel values of the difference between the input image and the base image and performing bit shift on the values resulting from the addition. As a result of the conversion, the pixel values of the pixels constituting the difference image Diff(x, y) can be within the range from 0 to 255.

Although the difference image generating unit 105 has been described on the assumption that the bit depth of images supported by the second encoder 106 is 8 bits, the bit depth of images supported by the second encoder 106 may be 10 bits. In this case, a method of offsetting information of 9 bits obtained as the difference between the input image and the base image to obtain values of 0 to 1024 and encoding the information as 10-bit information can also be considered. Furthermore, although the difference image generating unit 105 has been described on the assumption that the bit depths of the input image and the base image are 8 bits, other bit depths may be used. For example, the input image may have a bit depth of 8 bits and the base image may have a bit depth of 10 bits. In this case, it is preferable that the pixels be converted so that the input image and the base image have the same bit depth before generating the difference image. For example, by shifting the pixels constituting the input image to the left by 2 bits, the bit depth of the input image becomes 10 bits, which is the same as that of the base image. Alternatively, by shifting the pixels constituting the base image to the right by 2 bits, the bit depth of the base image becomes 8 bits, which is the same as that of the input image. Which of the bit depths to convert to depends on the bit depth of images supported by the second encoder 106. For example, if the bit depth of images supported by the second encoder 106 is 8 bits, the bit depths are converted so that the input image and the base image both have a bit depth of 8 bits, and the difference image is then generated as described above. If the bit depth of images supported by the second encoder 106 is 10 bits, the bit depths are converted so that the input image and the base image both have a bit depth of 10 bits, and the difference image is then generated. In this case, the pixels constituting the difference image need to be converted so that the difference image has a bit depth of 10 bits. Any method may be used for the conversion, but a method causing less error by the conversion is preferable.

Although the difference image generating unit 105 has a function of converting the pixel values of the pixels included in the difference image so that the pixel values of the pixels included in the difference image is within a specific range (a range of 0 to 255, for example) in the present embodiment as described above, the function of converting the pixel values of the pixels included in the difference image may alternatively be provided independently of the difference image generating unit 105, for example.

Subsequently, the second encoder 106 receives the difference image from the difference image generating unit 105, and performs the second encoding process on the difference image on the basis of the encoding parameters input from the encoding controller 108 to generate second encoded data. The second encoder 106 then sends the generated second encoded data to the multiplexer 107. Note that the second encoding process in the present embodiment is an encoding process performed by an encoder supporting the video coding techniques such as MPEG-2, H.264, and HEVC, but is not limited thereto. Alternatively, scalable coding may be performed as the second encoding process. For example, H.264/SVC that is scalable coding in H.264 can be used to divide the difference image into a base layer and an enhancement layer, which can achieve more flexible scalability.

Furthermore, in the present embodiment, the second encoding process at the second encoder 106 has a higher coding efficiency than the first encoding process at the first encoder 101. Specifically, a video coding technique having a higher coding efficiency is used for the second encoding process than that for the first encoding process, so that more efficient encoding can be performed. For example, when the first encoded data needs to be encoded in MPEG-2 as in digital broadcasting, the image quality of a decoded image can be improved with a small data amount by distributing second encoded data obtained by encoding in H.264 as extended data using an IP transmission network or the like.

Subsequently, the multiplexer 107 receives the filter information from the filter processor 104, and receives the second encoded data from the second encoder 106. The multiplexer 107 then multiplexes the filter information received from the filter processor 104 and the second encoded data received from the second encoder 106, and outputs the multiplexed data as extended data. Note that the first encoded data and the extended data may be transmitted over different transmission paths or may be further multiplexed and transmitted over one transmission path. The former case corresponds to a mode in which the first encoded data is broadcast using digital terrestrial broadcast and the extended data is distributed over an IP network. The latter case corresponds to a mode used for multicast such as IP multicast.

Next, effects of the filtering by the filter processor 104 will be described. In the present embodiment, low-pass filtering passing components with frequencies lower than the specific cutoff frequency is applied to the first decoded image to remove high frequency components containing encoding distortion that lowers the spatial correlation and the temporal correlation of the difference image. Note that the difference image between the base image generated by applying the low-pass filtering to the first decoded image and the input image includes low frequency components of the encoding distortion caused by the first encoding process and high frequency components of the input image. By the low-pass filtering, high frequency components of the encoding distortion are removed and the frequency components of the input image with relatively high spatial correlation and temporal correlation are increased, which results in improvement in both of the spatial correlation and the temporal correlation and in the coding efficiency of the second encoding process.

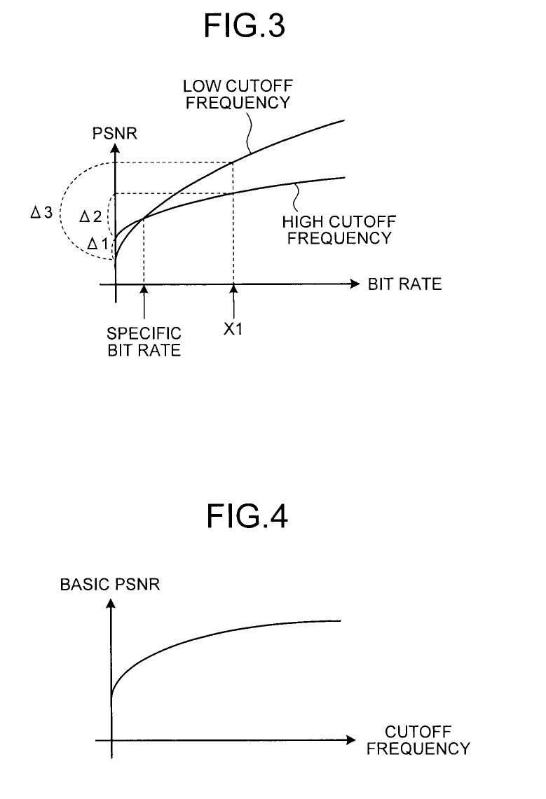

A method for determining the cutoff frequency will be described below. FIG. 3 is a conceptual graph illustrating a rate-distortion curve expressing the relation between the bit rate given to the second encoded data and the PSNR indicating the objective image quality of the second decoded image obtained by decoding the second encoded data. FIG. 3 illustrates two rate-distortion curves, one expressing the relation between the bit rate given to the second encoded data corresponding to the difference image to which low-pass filtering with a high cutoff frequency is applied (the second encoded data generated by performing the second encoding process on the difference image) and the PSNR of the second decoded image, and the other expressing the relation between the bit rate given to the second encoded data corresponding to the difference image to which low-pass filtering with a low cutoff frequency is applied and the PSNR of the second decoded image.

Note that the PSNR is an index indicating how much the image quality of the second decoded image is degraded from the difference image that is the original image, and a larger PSNR represents less degradation in the image quality of the second decoded image, that is, higher objective image quality of the second decoded image. The PSNR of the second decoded image can be expressed by the following equation (5):

$$PSNR = 10 {log}_{10} \frac{{255}^{2}}{MSE} \\ MSE = \frac{1}{mn} {\sum }_{x}^{m - 1} {\sum }_{y}^{n - 1} {( Diff ( x , y ) - Rec ( x , y ) )}^{2} \qquad ( 5 )$$

In the equation (5), Rec(x, y) represents a pixel value at coordinates (x, y) of the second decoded image. In addition, m represents the number of pixels in the horizontal direction and n represents the number of pixels in the vertical direction. As illustrated in FIG. 3, the two rate-distortion curves intersect each other, and at a bit rate lower than a certain bit rate, the PSNR of the second decoded image is higher when the difference image to which low-pass filtering with a high cutoff frequency is applied is encoded. At a bit rate higher than a certain bit rate, on the other hand, the PSNR of the second decoded image is higher when the difference image to which low-pass filtering with a low cutoff frequency is applied is encoded. The coding efficiency of the second encoding process can therefore be improved by appropriately determining the cutoff frequency depending on the bit rate given to the second encoded data.

While FIG. 3 illustrates the rate-distortion curves expressing the relation between the bit rate given to the second encoded data and the PSNR of the second decoded image, the PSNR of the second decoded image will be the same as that of a composite image generated by the associated video decoding device, which is not illustrated, (a composite image of the base image generated by performing the same filtering as that performed by the filter processor 104 and the second decoded image obtained by decoding the second encoded data) if the clipping is not performed in the equation (3). Thus, the rate-distortion curves illustrated in FIG. 3 can also be regarded as the rate-distortion curves expressing the relation between the bit rate given to the second encoded data and the PSNR of the composite image. Since clipping is rarely performed as described above, the PSNR of the composite image is substantially equal to that of the second decoded image. Consequently, by improving the coding efficiency of the second encoding process, the PSNR of the composite image generated by the associated video decoding device, which is not illustrated, can be improved.

Furthermore, if the second encoder 106 is skipped and the second encoded data is not output, the associated video decoding device does not decode the second encoded data and the composite image generated by the associated video decoding device will be the base image itself. In this case, the PSNR of the composite image can be deemed to be the PSNR of the second decoded image when the bit rate is as close to 0 as possible in the rate-distortion curves in FIG. 3. Herein, the PSNR of the second decoded image when the bit rate of the second encoded data is as close to 0 as possible in a rate-distortion curve is defined as “basic PSNR”.

Comparison between the basic PSNRs of the two rate-distortion curves illustrated in FIG. 3 demonstrates that the basic PSNR when the difference image to which low-pass filtering with a high cutoff frequency is applied is encoded is higher by Δ1 than the basic PSNR when the difference image to which low-pass filtering with a low cutoff frequency is applied is encoded. The basic PSNR can be calculated by the following equation (6):

$$Basic PSNR = 10 {log}_{10} \frac{{255}^{2}}{MSE} \\ MSE = \frac{1}{mn} {\sum }_{x}^{m - 1} {\sum }_{y}^{n - 1} {( org ( x , y ) - Base ( x , y ) )}^{2} \qquad ( 6 )$$

Next, the relation between the basic PSNR and the cutoff frequency will be described. As the cutoff frequency is lower, the frequency band to be cut off out of the frequency components of the first decoded image is lager and the frequency components of the input image contained in the difference image between the base image generated by applying filtering to the first decoded image and the input image increases. Typically, since the power (a square of amplitude) of the frequency components of the input image is larger than that of the encoding distortion, the energy (the total of the powers of the frequency components) of the difference image increases as the frequency components of the input image increase. In other words, since the mean square error MSE between the input image Org(x, y) and the base image Base(x, y) is larger as the cutoff frequency is lower (as the frequency components of the input image increase), the basic PSNR is smaller as can also be seen in the equation (6). FIG. 4 is a conceptual graph illustrating the relation between the cutoff frequency and the basic PSNR. As illustrated in FIG. 4, the basic PSNR increases monotonously as the cutoff frequency is higher.

In contrast, comparison of the improvement in the basic PSNR when the bit rate given to the second encoded data is fixed to x1 in FIG. 3 demonstrates that the basic PSNR is improved by Δ2 when the second encoded data obtained by encoding the difference image to which low-pass filtering with a high cutoff frequency is applied is output whereas the basic PSNR is improved by Δ3 larger than Δ2 when the second encoded data obtained by encoding the difference image to which low-pass filtering with a low cutoff frequency is applied is output.

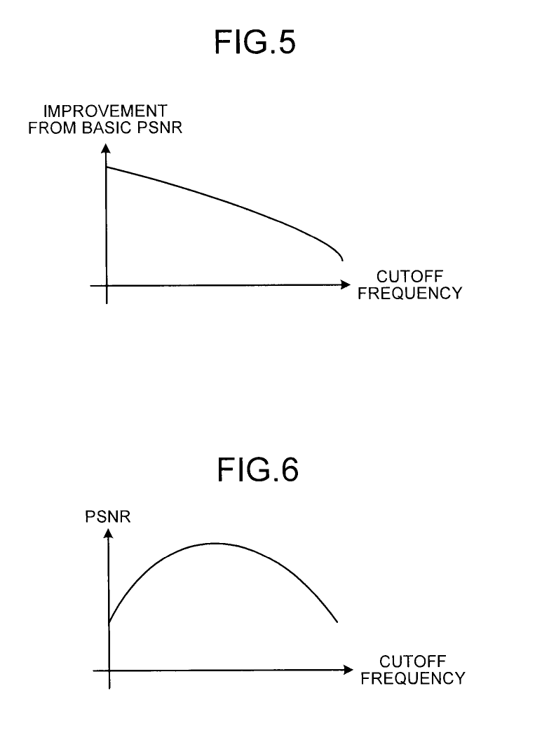

The relation between the improvement from the basic PSNR and the cutoff frequency will be described here. As described above, the spatial correlation and the temporal correlation of the encoding distortion caused by the first encoding process are lower than those of the input image, but with a lower cutoff frequency, the proportion of the frequency components of the input image is increased, and the spatial correlation and the temporal correlation of the difference image are thus improved, which results in an image easier to compress (easier to encode) using common video coding techniques. An image easier to compress has a larger improvement from the basic PSNR at a certain bit rate than an image harder to compress. FIG. 5 is a conceptual graph illustrating the relation between the cutoff frequency and the improvement from the basic PSNR at a certain bit rate. As illustrated in FIG. 5, the improvement from the basic PSNR decreases monotonously as the cutoff frequency is higher. In other words, the improvement from the basic PSNR increases monotonously as the cutoff frequency is lower.

Thus, with a low cutoff frequency, the basic PSNR is low but the improvement from the basic PSNR at a certain bit rate is large. Conversely, with a high cutoff frequency, the basic PSNR is high but the improvement from the basic PSNR at a certain bit rate is small. The PSNR of the second decoded image is a sum of the basic PSNR and the improvement from the basic PSNR. Thus, when the bit rate given to the second encoded data is fixed, the relation between the cutoff frequency and the PSNR of the second decoded image is expressed by a concave down curve (a parabola having a maximum point) as illustrated in FIG. 6. Consequently, the maximum point of the curve expressing the relation between the cutoff frequency and the PSNR of the second decoded image can be uniquely determined to be the cutoff frequency with which the PSNR of the second decoded image is maximum (hereinafter may be referred to as “maximum cutoff frequency”). As described above, it is found in the present embodiment that the relation between the cutoff frequency and the PSNR of the second decoded image at each bit rate is expressed by a parabola having a maximum point.

In the present embodiment, as described above, the relation between the bit rate given to the second encoded data and the maximum cutoff frequency is calculated in advance using various input images, and information in the form of a table (hereinafter may be referred to as table information) in which the maximum cutoff frequency is associated with each bit rate to be given to the second encoded data is held by the storage unit 201 illustrated in FIG. 2. In the present embodiment, the second determining unit 202 illustrated in FIG. 2 receives the bit rate to be given to the second encoded data as an encoding parameter from the encoding controller 108, and refers to the table information held by the storage unit 201 to identify the maximum cutoff frequency associated with the bit rate given to the second encoded data. The second determining unit 202 then determines the identified maximum cutoff frequency as the cutoff frequency to be used for filtering by the filter processor 104, and sends filter information indicating the determined cutoff frequency to each of the filter processor 104 and the multiplexer 107.

Alternatively, the relation between the bit rate to be given to the second encoded data and the maximum cutoff frequency can be calculated in advance using various input images, and information on the relation that is converted to a mathematical model (hereinafter may be referred to as mathematical model information) can be held by the storage unit 201 illustrated in FIG. 2. In this case, the second determining unit 202 illustrated in FIG. 2 receives the bit rate to be given to the second encoded data as an encoding parameter from the encoding controller 108, identifies the maximum cutoff frequency associated from the mathematical model information held by the storage unit 201, and determines the identified maximum cutoff frequency to be the cutoff frequency to be used for filtering. The second determining unit 202 then sends filter information indicating the determined cutoff frequency to each of the filter processor 104 and the multiplexer 107.

Note that the table information and the mathematical model information mentioned above correspond to “relation information” in the claims, but the relation information is not limited thereto.

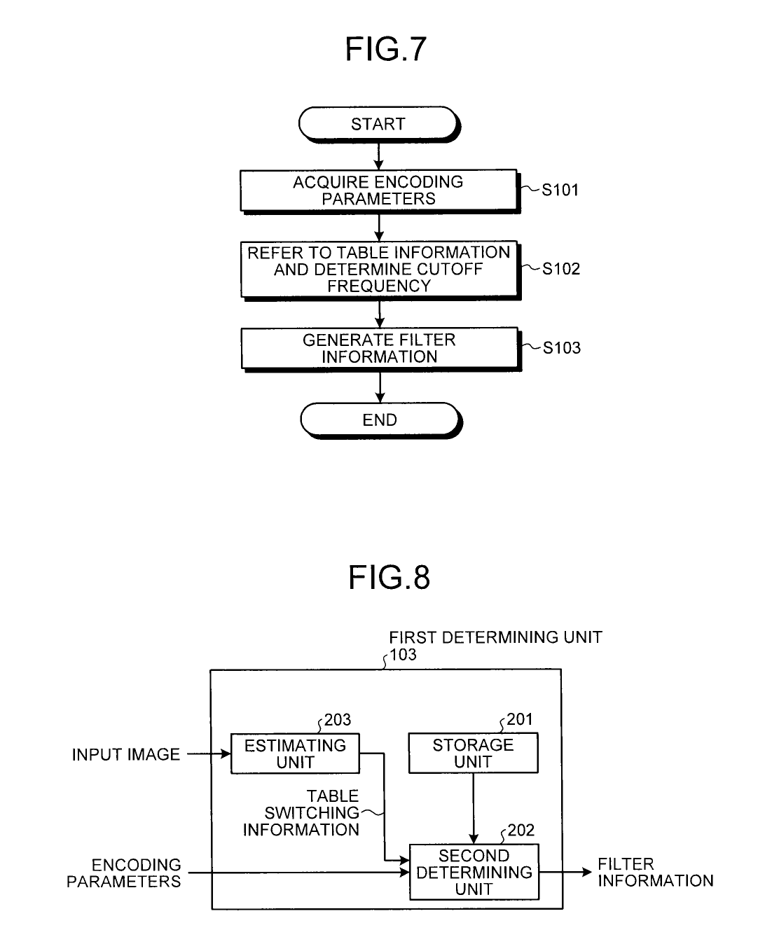

FIG. 7 is a flowchart illustrating an example of processing performed by the first determining unit 103. As illustrated in FIG. 7, the second determining unit 202 first acquires encoding parameters including the bit rate to be given to the second encoded data from the encoding controller 108 (step S101). Subsequently, the second determining unit 202 refers to the table information held by the storage unit 201 to determine the cutoff frequency to be used for filtering (step S102). More specifically, the second determining unit 202 refers to the table information held by the storage unit 201 to identify the maximum cutoff frequency associated with the bit rate to be given to the second encoded data, and determines the identified maximum cutoff frequency as the cutoff frequency to be used for filtering.

Subsequently, the second determining unit 202 generates filter information indicating the cutoff frequency to be used for filtering (step S103). The second determining unit 202 then sends the generated filter information to each of the filter processor 104 and the multiplexer 107.

As described above, the video encoding device 100 according to the present embodiment performs scalable coding to output first encoded data generated by performing a first encoding process on an input image and second encoded data generated by performing a second encoding process on a difference image between the input image and a base image that is a low-quality image obtained by decoding the first encoded data. The video encoding device 100 then performs low-pass filtering passing components with frequency lower than a specific cutoff frequency out of the frequency components of the first decoded image obtained by decoding the first encoded data to generate a base image before generating the difference image. Note that the difference image between the base image generated by applying the low-pass filtering to the first decoded image and the input image includes low frequency components of the encoding distortion caused by the first encoding process and high frequency components of the input image. By the low-pass filtering, high frequency components of the encoding distortion are removed and the frequency components of the input image with relatively high spatial correlation and temporal correlation are increased, which results in improvement in both of the spatial correlation and the temporal correlation of the difference image and in the coding efficiency of the second encoding process.

### Modified Example 1 of First Embodiment

For example, the first determining unit 103 described above can further include an estimating unit to estimate the encoding distortion caused by the first encoding process on the basis of at least one of the input image, the first encoded data, and the first decoded image. In this case, the storage unit 201 stores different relation information (information indicating the relation between the bit rate given to the second encoded data and the maximum cutoff frequency) depending on the encoding distortion. The second determining unit 202 can use the relation information associated with the encoding distortion estimated by the estimating unit to identify the maximum cutoff frequency associated with the specified bit rate, and determine the identified maximum cutoff frequency to be the cutoff frequency to be used for filtering. Specific details thereof will be described below.

FIG. 8 is a block diagram illustrating a detailed exemplary configuration of the first determining unit 103 according to the modified example 1. As illustrated in FIG. 8, the first determining unit 103 further includes an estimating unit 203. In this example, the estimating unit 203 estimates encoding distortion on the basis of an input image. Details thereof will be described later.

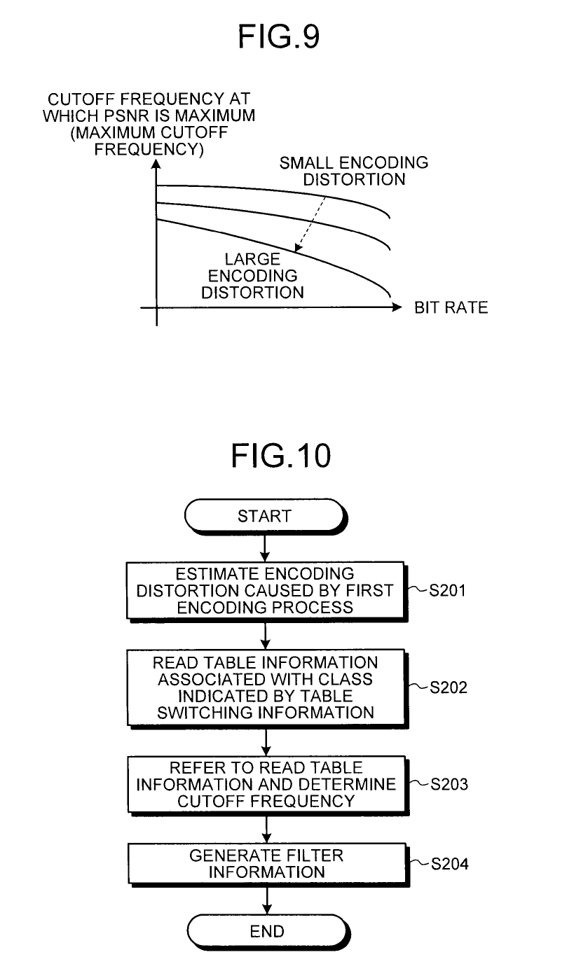

Note that the basic PSNR and the improvement from the basic PSNR at a certain bit rate vary depending on the encoding distortion caused by the first encoding process. As the encoding distortion is larger, the mean square error MSE between the input image Org(x, y) and the base image Base(x, y) in the equation (6) increases and the basic PSNR is thus smaller. Furthermore, the improvement from the basic PSNR is also smaller by an amount corresponding to lower spatial correlation and temporal correlation of the encoding distortion. As described above, since the improvement from the basic PSNR increases monotonously as the cutoff frequency is lower, it is preferable to set the cutoff frequency to be lower as the encoding distortion is larger and to set the cutoff frequency to be higher as the encoding distortion is smaller as illustrated in FIG. 9.

It is therefore preferable to set the relation information indicating the relation between the bit rate given to the second encoded data and the maximum cutoff frequency to be variable depending on the encoding distortion caused by the first encoding process. More specifically, it is preferable to set the relation information so that the maximum cutoff frequency associated with a specific bit rate is smaller as the encoding distortion is larger as illustrated in FIG. 9. In this example, the encoding distortion is classified into one or more classes, and table information indicating the relation between the bit rate given to the second encoded data and the maximum cutoff frequency (for example, information in the form of a table in which each possible bit rate is associated with a maximum cutoff frequency) is held for each class by the storage unit 201. Thus, the storage unit 201 holds the same number of pieces of table information as the number of classes.

Alternatively, table information indicating the relation among the bit rate given to the second encoded data, the maximum cutoff frequency, and the encoding distortion caused by the first encoding process may be calculated and held in advance, for example. In this case, the storage unit 201 only needs to hold one piece of table information. Still alternatively, the relation among the bit rate given to the second encoded data, the maximum cutoff frequency, and the encoding distortion caused by the first encoding process may be converted to a mathematical model in advance and mathematical model information indicating the mathematical model may be held by the storage unit 201, for example. In this case, the classification is not necessary. Basically, the storage unit 201 may be in any form storing relation information that is different (varies) depending on the encoding distortion caused by the first encoding process.

The description is continued referring back to FIG. 8. The estimating unit 203 receives an input image, and estimates the encoding distortion caused by the first encoding process according to a specific criterion. The estimating unit 203 then classifies the estimated encoding distortion as one of one or more classes, and sends information indicating the class as which the encoding distortion is classified as table switching information to the second determining unit 202.

As described above, the storage unit 201 holds the table information for each class. The second determining unit 202 also receives the bit rate given to the second encoded data as an encoding parameter from the encoding controller 108, and receives the table switching information from the estimating unit 203. The second determining unit 202 reads out the table information associated with the class indicated by the table switching information received from the estimating unit 203 from the storage unit 201. The second determining unit 202 then refers to the read table information to identify the maximum cutoff frequency associated with the bit rate (encoding parameter) given to the second encoded data received from the encoding controller 108, and determines the identified maximum cutoff frequency as the cutoff frequency to be used for filtering.

In this example, an image feature quantity capable of quantitatively evaluating the spatial correlation and the temporal correlation is used as the specific criterion. For example, the spatial correlation can be quantitatively evaluated by calculating an image feature quantity such as correlation between adjacent pixels or frequency distribution. Furthermore, the temporal correlation can be quantitatively evaluated by calculating the amount of motion in a frame. Typically, an image having such features as a low correlation between adjacent pixels, a high spatial frequency, and a large amount of motion has low spatial correlation and temporal correlation, and thus encoding distortion easily occurs. In this example, the estimating unit 203 calculates the image feature quantity of the received input image, and estimates the encoding distortion caused by the first encoding process on the basis of the calculated image feature quantity. Note that the encoding distortion may be estimated for each specific region. In this case, information indicating a region to which filtering is to be applied needs to be further contained in the filter information, but the efficiency of encoding the difference image can be increased by switching the filter depending on the size of the encoding distortion.

FIG. 10 is a flowchart illustrating an example of processing performed by the first determining unit 103 according to the modified example 1. As illustrated in FIG. 10, the estimating unit 203 first estimates the encoding distortion caused by the first encoding process (step S201). More specifically, the estimating unit 203 calculates the image feature quantity of the received input image, and estimates the encoding distortion on the basis of the calculated image feature quantity. The estimating unit 203 classifies the estimated encoding distortion as one of one or more classes, and sends information indicating the class as which the encoding distortion is classified as table switching information to the second determining unit 202.

Subsequently, the second determining unit 202 reads out the table information associated with the class indicated by the table switching information received from the estimating unit 203 from the storage unit 201 (step S202). Subsequently, the second determining unit 202 refers to the read table information to determine the cutoff frequency to be used for filtering (step S203). More specifically, the second determining unit 202 refers to the table information read in step S202 to identify the maximum cutoff frequency associated with the bit rate (encoding parameter) given to the second encoded data received from the encoding controller 108, and determines the identified maximum cutoff frequency as the cutoff frequency to be used for filtering.

Subsequently, the second determining unit 202 generates filter information indicating the cutoff frequency to be used for filtering (step S204). The second determining unit 202 then sends the generated filter information to each of the filter processor 104 and the multiplexer 107.

In this example, as described above, the table information is switched depending on the encoding distortion caused by the first encoding process, the switched table information is referred to, and the maximum cutoff frequency associated with the bit rate given to the second encoded data is determined to be the cutoff frequency to be used for filtering. As a result, since the influence of the encoding distortion caused by the first encoding process on the coding efficiency of the second encoding process can be further reduced, the coding efficiency of the second encoding process can be further improved.

### Modified Example 2 of First Embodiment

While the estimating unit 203 estimates the encoding distortion caused by the first encoding process on the basis of the input image in the modified example 1 described above, the estimating unit 203 can alternatively estimate the encoding distortion on the basis of the first encoded data. Specific details thereof will be described below.

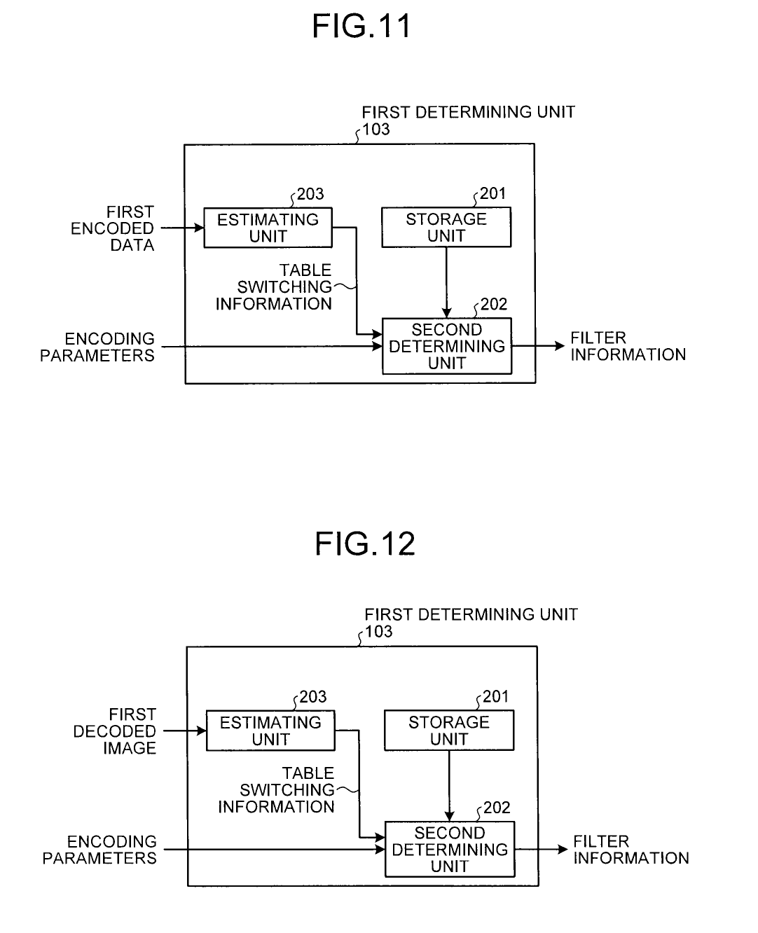

FIG. 11 is a block diagram illustrating a detailed exemplary configuration of the first determining unit 103 according to the modified example 2. The estimating unit 203 illustrated in FIG. 11 receives the first encoded data from the first encoder 101, and estimates the encoding distortion caused by the first encoding process according to a specific criterion. The estimating unit 203 then classifies the estimated encoding distortion as one of one or more classes, and sends information indicating the class as which the encoding distortion is classified as table switching information to the second determining unit 202.

Similarly to the modified example 1 described above, the storage unit 201 holds the table information for each class. Furthermore, similarly to the modified example 1 described above, the second determining unit 202 receives the bit rate given to the second encoded data as an encoding parameter from the encoding controller 108, and receives the table switching information from the estimating unit 203. The second determining unit 202 reads out the table information associated with the class indicated by the table switching information received from the estimating unit 203 from the storage unit 201. The second determining unit 202 then refers to the read table information to identify the maximum cutoff frequency associated with the bit rate (encoding parameter) given to the second encoded data received from the encoding controller 108, and determines the identified maximum cutoff frequency as the cutoff frequency to be used for filtering.

In this example, an encoding parameter such as a quantization parameter or the length of a motion vector capable of estimating the encoding distortion caused by the first encoding process are used as the specific criterion. Any method may be used for the estimating method, and it can typically be estimated that a larger encoding distortion occurs as the value of the quantization parameter is larger or the length of the motion vector is longer. In this example, the estimating unit 203 uses the first encoded data received from the first encoded data received from the first encoder 101 and the encoding parameter received from the encoding controller 108 to estimate the encoding distortion caused by the first encoding process. Note that the encoding distortion may be estimated for each specific region. In this case, information indicating a region to which filtering is to be applied needs to be further contained in the filter information, but by switching the filter depending on the size of the encoding distortion, the efficiency of encoding the difference image can be increased.

Since the process flow performed by the first determining unit 103 in this example is the same as that in the example of FIG. 10, detailed description thereof will not be repeated. In the modified example 2, since the table information is switched depending on the encoding distortion caused by the first encoding process, the switched table information is referred to, and the maximum cutoff frequency associated with the bit rate given to the second encoded data is determined to be the cutoff frequency to be used for filtering, the coding efficiency of the second encoding process can also be further improved.

### Modified Example 3 of First Embodiment

For example, the estimating unit 203 can also estimate the encoding distortion on the basis of the first decoded image. Specific details thereof will be described below.

FIG. 12 is a block diagram illustrating a detailed exemplary configuration of the first determining unit 103 according to the modified example 3. The estimating unit 203 illustrated in FIG. 12 receives the first decoded image from the first decoder 102, and estimates the encoding distortion caused by the first encoding process according to a specific criterion. The estimating unit 203 then classifies the estimated encoding distortion as one of one or more classes, and sends information indicating the class as which the encoding distortion is classified as table switching information to the second determining unit 202.

Similarly to the modified example 1 described above, the storage unit 201 holds the table information for each class. Furthermore, similarly to the modified example 1 described above, the second determining unit 202 receives the bit rate given to the second encoded data as an encoding parameter from the encoding controller 108, and receives the table switching information from the estimating unit 203. The second determining unit 202 reads out the table information associated with the class indicated by the table switching information received from the estimating unit 203 from the storage unit 201. The second determining unit 202 then refers to the read table information to identify the maximum cutoff frequency associated with the bit rate (encoding parameter) given to the second encoded data received from the encoding controller 108, and determines the identified maximum cutoff frequency as the cutoff frequency to be used for filtering.

In this example, an image feature quantity capable of quantitatively evaluating the spatial correlation and the temporal correlation is used as the specific criterion. For example, the spatial correlation can be quantitatively evaluated by calculating an image feature quantity such as correlation between adjacent pixels or frequency distribution. Furthermore, the temporal correlation can be quantitatively evaluated by calculating the amount of motion in a frame. Typically, if the first decoded image has such features as a low correlation between adjacent pixels, a high spatial frequency, and a large amount of motion, it can be estimated that the spatial correlation and the temporal correlation of the input image are low and that the encoding distortion caused by the first encoding process is large. In this example, the estimating unit 203 calculates the image feature quantity of the received first decoded image, and estimates the encoding distortion caused by the first encoding process on the basis of the calculated image feature quantity. Note that the encoding distortion may be estimated for each specific region. In this case, information indicating a region to which filtering is to be applied needs to be further contained in the filter information, but by switching the filter depending on the size of the encoding distortion, the efficiency of encoding the difference image can be increased.

Since the process flow performed by the first determining unit 103 in this example is the same as that in the example of FIG. 10, detailed description thereof will not be repeated. In the modified example 3, since the table information is switched depending on the encoding distortion caused by the first encoding process, the switched table information is referred to, and the maximum cutoff frequency associated with the bit rate given to the second encoded data is determined to be the cutoff frequency to be used for filtering, the coding efficiency of the second encoding process can also be further improved.

### Modified Example 4 of First Embodiment

The modified examples 1 to 3 described above can be arbitrarily combined for estimation of the encoding distortion caused by the first encoding process. In other words, the estimating unit 203 may have any configuration having a function of estimating the encoding distortion caused by the first encoding process on the basis of at least one of the input image, the first encoded data, and the first decoded image.

### Second Embodiment

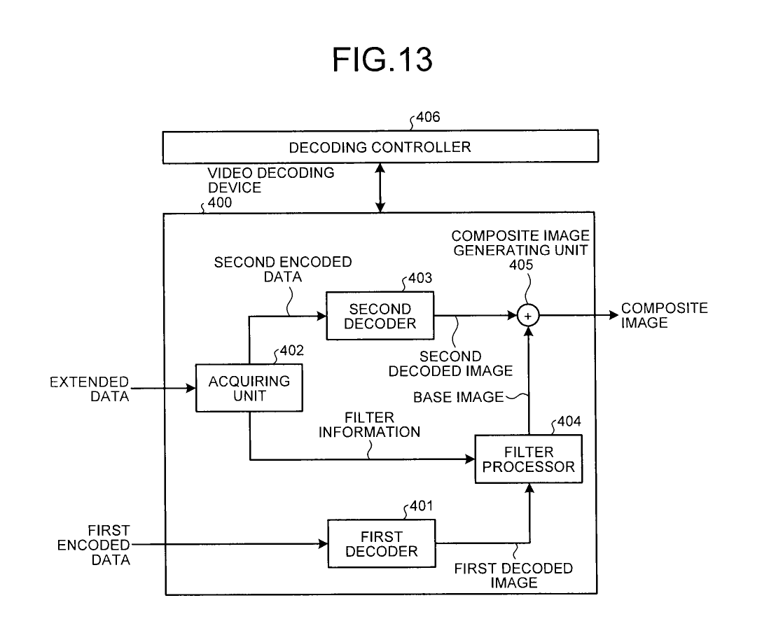

Next, a second embodiment will be described. In the second embodiment, a video decoding device associated with the video encoding device 100 described above will be described. FIG. 13 is a block diagram illustrating the configuration of a video decoding device 400 associated with the video encoding device 100 described above, and a decoding processor 406 that externally controls frame synchronization and the like of the video encoding device 100. As illustrated in FIG. 13, the video decoding device 400 includes a first decoder 401, an acquiring unit 402, a second decoder 403, a filter processor 404, and a composite image generating unit 405.

The first decoder 401 performs the first decoding process on first encoded data generated by performing the first encoding process on an input image to generate a first decoded image. More specifically, the first decoder 401 receives the first encoded data generated by performing the first encoding process on the input image from outside (for example, the video encoding device 100 described above), and performs the first decoding process on the received first encoded data to generate the first decoded image. The first decoder 401 then sends the generated decoded image to the filter processor 404. The first decoding process is a counterpart of the first encoding process performed by the video encoding device 100 (the first encoder 101) described above. For example, if the first encoding process performed by the first encoder 101 is an encoding process based on MPEG-2, the first decoding process is a decoding process based on MPEG-2. In this example, the first decoding process performed by the first decoder 401 is the same as the first decoding process performed by the first decoder 102 of the video encoding device 100 described above.

The acquiring unit 402 externally acquires extended data containing second encoded data generated by performing second encoding process on a difference image between an input image and a base image generated by filtering the first decoded image by cutting off a specific frequency band of the frequency components and filter information indicating the specific frequency band. The acquiring unit 402 performs a separation process to separate the acquired extended data into the second encoded data and the filter information, sends the second encoded data obtained by the separation to the second decoder 403, and sends the filter information obtained by the separation to the filter processor 404.

The second decoder 403 performs a second decoding process on the second encoded data received from the acquiring unit 402 to generate a second decoded image. The second decoder 403 then sends the generated second decoded image to the composite image generating unit 405. The second decoding process is a counterpart of the second encoding process performed by the video encoding device 100 (the second encoder 106) described above. For example, if the second encoding process performed by the second encoder 106 is an encoding process based on H.264, the second decoding process is a decoding process based on H.264.

The filter processor 404 performs filtering to cut off a specific frequency band indicated by the filter information received from the acquiring unit 402 out of the frequency components of the first decoded image generated by the first decoder 401 to generate a base image. In the present embodiment, since the filter information received from the acquiring unit 402 indicates the cutoff frequency determined by the first determining unit 103 of the video encoding device 100 described above, the filter processor 404 performs low-pass filtering passing components with frequencies lower than the cutoff frequency indicated by the filter information received from the acquiring unit 402 out of the frequency components of the first decoded image generated by the first decoder 401 to generate the base image. The filtering by the filter processor 404 is the same as that by the filter processor 104 of the video encoding device 100 described above. The filter processor 404 then sends the generated base image to the composite image generating unit 405.

The composite image generating unit 405 generates a composite image based on the base image generated by the filter processor 404 and the second decoded image. More specifically, the composite image generating unit 405 performs a specific addition process on the base image received from the filter processor 404 and the second decoded image received from the second decoder 403 to generate the composite image. For example, the addition process is a counterpart of a subtraction process performed by the difference image generating unit 105 of the video encoding device 100 described above. If the difference image generating unit 105 calculates the difference according to the equation (3), the composite image generating unit 405 performs the addition process based on the following equation (7):

Sum(x,y)=clip(Diff(x,y)+Base(x,y)−128,0,255) (7)

In the equation (7), Sum(x, y) represents a pixel value at coordinates (x, y) of the composite image, Base(x, y) represents a pixel value at coordinates (x, y) of the base image, and Diff(x, y) represents a pixel value at coordinates (x, y) of the second decoded image.

The above is the decoding method for the video decoding device 400 associated with the video encoding device 100 described above.

### Third Embodiment

Next, a third embodiment will be described. A modification of the video encoding device 100 according to the first embodiment will be described here. Description of parts that are the same as those in the first embodiment described above will not be repeated as appropriate.

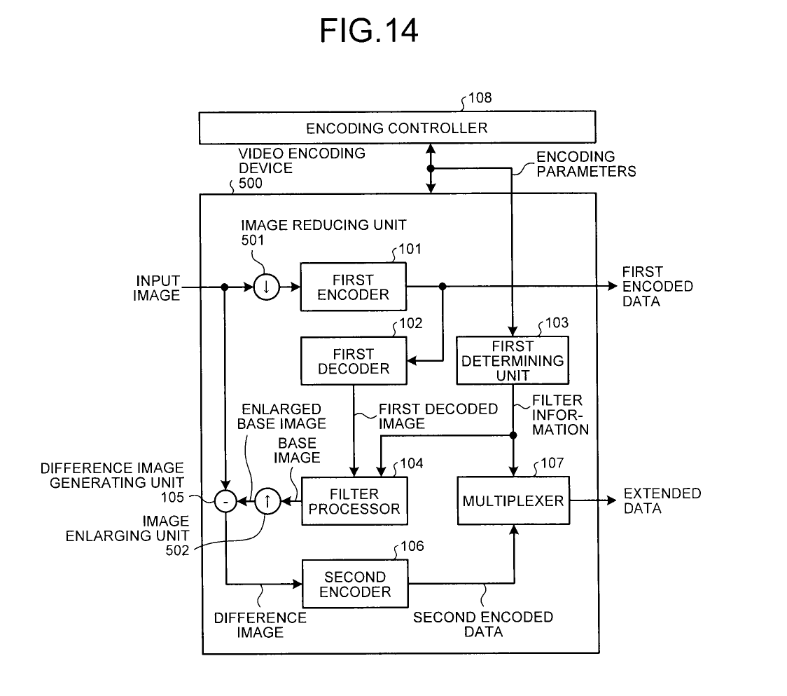

FIG. 14 is a block diagram illustrating the configuration of a video encoding device 500 according to the present embodiment, and the encoding controller 108 that externally controls encoding parameters, frame synchronization, and the like of the video encoding device 500. As illustrated in FIG. 14, the video encoding device 500 differs from the video encoding device 100 according to the first embodiment described above in further including an image reducing unit 501 and an image enlarging unit 502.

The image reducing unit 501 has a function of reducing the resolution of the input image before generation of the first encoded data. More specific description is given below. The image reducing unit 501 performs a specific image reduction process on the input image to generate a reduced input image that is the input image with a reduced resolution. For example, if the first encoded data generated by the first encoder 101 is assumed to be broadcast using digital terrestrial broadcast, the resolution of images input to the first encoder 101 is 1440 horizontal pixels (the number of pixels in a row)×1080 vertical pixels (the number of pixels in a column). Typically, this is subjected to image enlargement by a receiver and displayed as video with a resolution of 1920 horizontal pixels×1080 vertical pixels. In this case, if the resolution of an input image is 1920 horizontal pixels×1080 vertical pixels, for example, the image reducing unit 501 performs an image reduction process of reducing the resolution of the input image to 1440 horizontal pixels×1080 vertical pixels. The image reducing unit 501 then sends the generated reduced input image to the first encoder 101, and the first encoder 101 in turn performs the first encoding process on the reduced input image (the input image with the resolution reduced by the image reducing unit 501) received from the image reducing unit 501.

The image reduction process may be performed using a bilinear or bicubic image reduction technique in addition to simple sampling, or may be performed by specific filtering. The image reduction process in the present embodiment may switch between multiple means mentioned above or may switch between parameters for the means for each region.

The image enlarging unit 502 has a function of increasing the resolution of the base image before generation of the difference image. More specific description is given below. The image enlarging unit 502 receives the base image from the filter processor 104, and performs a specific image enlargement process on the base image to generate an enlarged base image having the same resolution as the input image. In the present embodiment, the base image output from the filter processor 104 is output as an image with a resolution lower than that of the input image, but by generating the enlarged base image by increasing the resolution by the image enlarging unit 502 before generating a difference image between the enlarged base image and the input image by the difference image generating unit 105, the image quality of the composite image displayed by a receiver can be improved.

The image enlargement process in the present embodiment may be performed by using a bilinear or bicubic image enlargement technique, or may be performed by using specific filtering or super resolution utilizing the self-similarity of images. When an image is to be enlarged by using super resolution, a method of extracting and using similar regions within a frame of the base image, a method of extracting similar regions from multiple frames and reproducing a desired phase, or the like may be used. The image enlargement process in the present embodiment may switch between multiple means mentioned above or may switch between parameters for the means for each region. In this case, the switching may be based on a specific criterion, or information such as an index indicating the means set at the encoder side may be contained as additional data in the extended data mentioned above.

Note that the image enlargement process at the image enlarging unit 502 according to the present embodiment may be included in a band-limiting filtering at the filter processor 104. In this case, since the band-limiting filtering and the image enlargement process can be performed as one process, it is not necessary to provide hardware for each of the processes and a memory for temporarily saving the base image is not needed. As a result, the circuit size for realization by hardware can be made smaller. Furthermore, the processing speed during software execution can be increased.

The input image may have any resolution, and may have a resolution of 3840 horizontal pixels×2160 vertical pixels, which is commonly called 4K2K, for example. The reduced input image may have any resolution smaller than that of the input image. In this manner, any resolution scalability can be realized by combination of the resolution of the input image and that of the reduced input image. While only the image quality scalability can be achieved in the first embodiment described above, the spatial resolution scalability can be achieved by adding the image reducing unit 501 and the image enlarging unit 502 in the present embodiment.

### Fourth Embodiment

Next, a fourth embodiment will be described. In the fourth embodiment, a video decoding device associated with the video encoding device 500 according to the third embodiment described above will be described. Description of parts that are the same as those of the video decoding device 400 according to the second embodiment described above will not be repeated as appropriate.

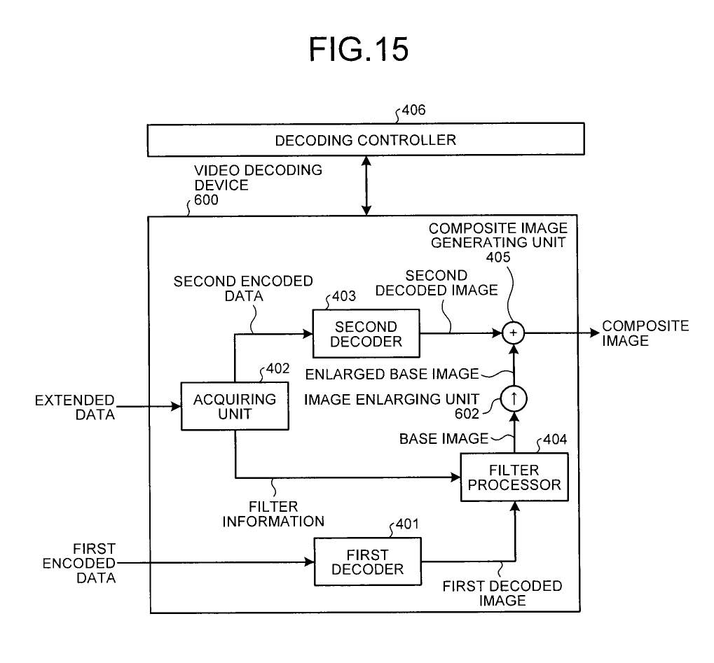

FIG. 15 is a block diagram illustrating the configuration of a video decoding device 600 associated with the video encoding device 500 described above, and the decoding processor 406 that externally controls frame synchronization and the like of the video encoding device 500. As illustrated in FIG. 15, the video decoding device 600 differs from the video decoding device 400 according to the second embodiment described above in further including an image enlarging unit 602.

The image enlarging unit 602 has a function of increasing the resolution of the base image generated by the filter processor 404. More specifically, the image enlarging unit 602 receives the base image from the filter processor 404, and performs a specific image enlargement process on the base image to generate an enlarged base image having the same resolution as the second decoded image. Herein, the image enlargement process at the image enlarging unit 602 is assumed to be the same as the image enlargement process performed by the image enlarging unit 502 of the video encoding device 500 according to the third embodiment described above. The above is the decoding method for the video decoding device 600 according to the present embodiment.

### Fifth Embodiment

Next, a fifth embodiment will be described. A modification of the video encoding device 100 according to the first embodiment will be described here. Description of parts that are the same as those in the first embodiment described above will not be repeated as appropriate.

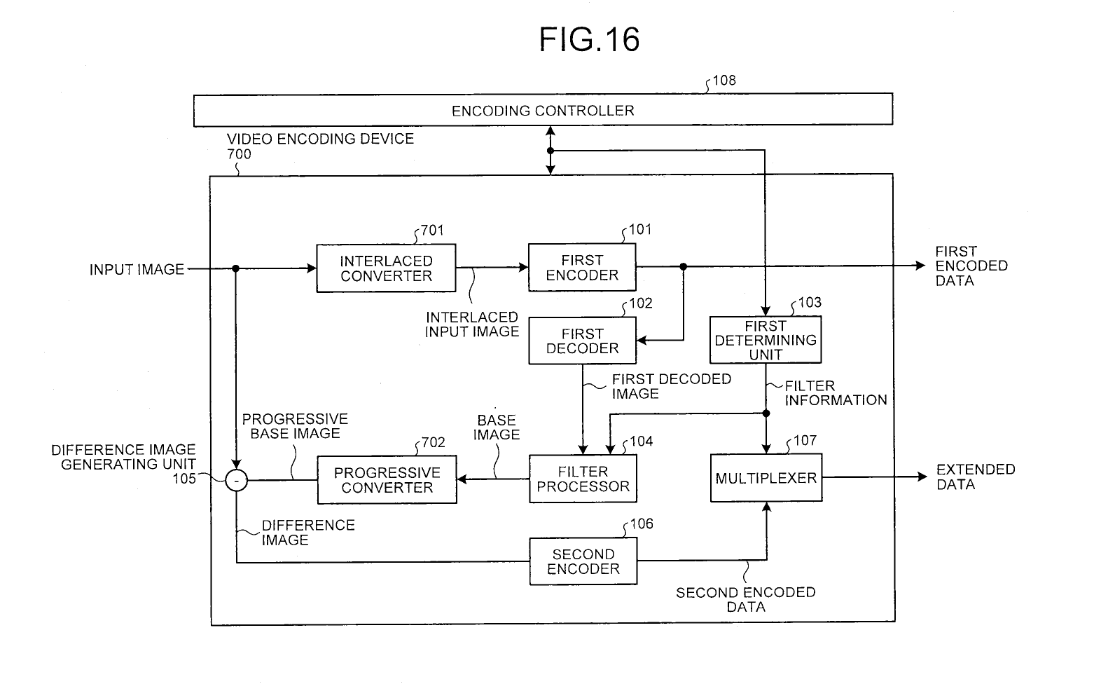

FIG. 16 is a block diagram illustrating the configuration of a video encoding device 700 according to the present embodiment, and the encoding controller 108 that externally controls encoding parameters, frame synchronization, and the like of the video encoding device 700. As illustrated in FIG. 16, the video encoding device 700 differs from the video encoding device 100 according to the first embodiment described above in further including an interlaced converter 701 and a progressive converter 702.

The interlaced converter 701 receives an input image in a progressive format and performs specific conversion to an interlaced format on the input image to generate the input image in the interlaced format (may be referred to as an “interlaced input image” in the description below). The specific conversion to the interlaced format is achieved by intermittently thinning out one horizontal pixel line (thinning out even-numbered horizontal scanning lines or thinning out odd-numbered horizontal scanning lines, for example) of the input image so that top fields and bottom fields are temporally alternated. In the specific conversion to the interlaced format, the thinning may be performed after applying a specific low-pass filter to the vertical direction of the input image. Alternatively, the thinning may be performed after detecting motion in an image and applying a specific low-pass filter only to regions in which motion is detected. The cutoff frequency of the specific low-pass filter is preferably within a range that does not cause an aliasing noise when the vertical resolution of an image is halved.

By the conversion to the interlaced format by the interlaced converter 701, the base image generated by the filter processor 104 becomes an image in an interlaced format. The progressive converter 702 receives the base image in the interlaced format from the filter processor 104, and performs specific conversion to the progressive format on the base image to generate the base image in the progressive format (may be referred to as a “progressive base image” in the description below). In the present embodiment, the base image generated by the filter processor 104 is output as an image in the interlaced format, but as a result of converting the base image the progressive base image in the progressive format by the progressive converter 702 before generating a difference image between the progressive base image and the input image by the difference image generating unit 105, the image quality of the composite image displayed by a receiver can be improved.

The specific conversion to the progressive format may be an image enlargement process that doubles the vertical resolution of the base image. For example, a bilinear or bicubic image enlargement technique may be used, or specific filtering or super resolution utilizing the self-similarity of images may be used. When an image is to be enlarged by using super resolution, a method of extracting and using similar regions within a frame of the base image, a method of extracting similar regions from multiple frames and reproducing a desired phase, or the like may be used. Alternatively, the specific conversion to the progressive format may be an image enlargement process that detects motion in an image and doubles the vertical resolution of the base image for regions in which motion is detected. Still alternatively, interpolation may be performed by copying pixels at the same positions in successive frames as the pixel positions to be interpolated only in regions in which no motion is detected, and weighted addition of interpolated pixels obtained by doubling the vertical resolution of the base image may further be performed. The conversion to the progressive format in the present embodiment may switch between multiple means mentioned above or may switch between parameters for the means for each region. In this case, the switching may be based on a specific criterion, or information such as an index indicating the means set at the encoder side may be contained as additional data in the extended data mentioned above.

In the first encoding process and the second encoding process in the present embodiment, encoding may be performed on an image in the interlaced format as an input or encoding may be performed assuming an image in the interlaced format to be an image in the progressive format. While only the image quality scalability can be achieved in the first embodiment described above, the temporal resolution scalability (which can also be regarded as the spatial resolution scalability) can be achieved by adding the interlaced converter 701 and the progressive converter 702 in the present embodiment.

### Sixth Embodiment

Next, a sixth embodiment will be described. In the sixth embodiment, a video decoding device associated with the video encoding device 700 according to the fifth embodiment described above will be described. Description of parts that are the same as those of the video decoding device 400 according to the second embodiment described above will not be repeated as appropriate.

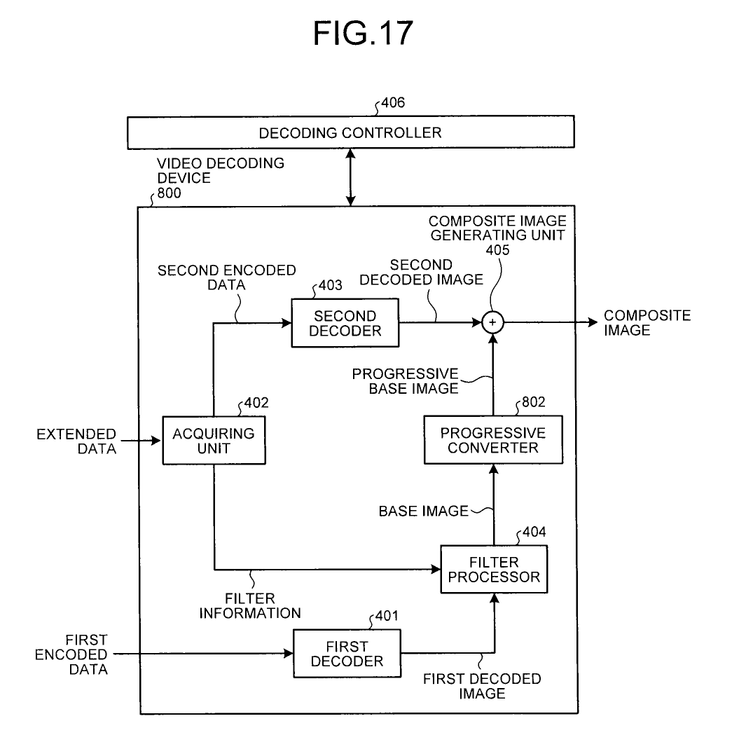

FIG. 17 is a block diagram illustrating the configuration of a video decoding device 800 associated with the video encoding device 700 described above, and the decoding processor 406 that externally controls frame synchronization and the like of the video encoding device 700. As illustrated in FIG. 17, the video decoding device 800 differs from the video decoding device 400 according to the second embodiment described above in further including a progressive converter 802.

The progressive converter 802 receives the base image from the filter processor 404, and performs specific conversion to the progressive format on the base image to generate the progressive base image in the progressive format. The specific conversion to the progressive format at the progressive converter 702 is assumed to be the same as the conversion to the progressive format performed by the progressive converter 802 of the video encoding device 700 according to the fifth embodiment described above. The above is the decoding method for the video decoding device 600 according to the present embodiment.

### Seventh Embodiment

Next, a seventh embodiment will be described. A modification of the video encoding device 100 according to the first embodiment will be described here. Description of parts that are the same as those in the first embodiment described above will not be repeated as appropriate.

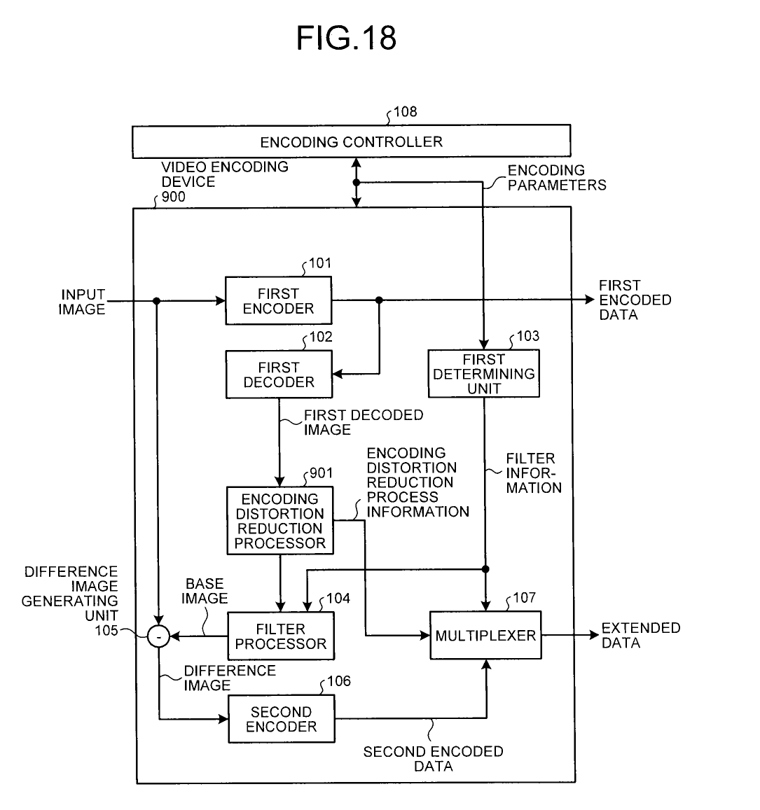

FIG. 18 is a block diagram illustrating the configuration of a video encoding device 900 according to the present embodiment, and the encoding controller 108 that externally controls encoding parameters, frame synchronization, and the like of the video encoding device 900. As illustrated in FIG. 18, the video encoding device 900 differs from the video encoding device 100 according to the first embodiment described above in further including an encoding distortion reduction processor 901.

The encoding distortion reduction processor 901 performs a specific encoding distortion reduction process on the first decoded image generated by the first decoder 102 to generate an encoding distortion reduced image in which the encoding distortion caused by the first encoding process is reduced. The encoding distortion reduction processor 901 then sends the generated encoding distortion reduced image to the filter processor 104.

As described above, since the encoding distortion caused by the first encoding process is directly superimposed on the difference image, the encoding distortion affects the coding efficiency of the second encoding process. Furthermore, a difference image cannot be efficiently encoded by using common video coding techniques. Thus, in the present embodiment, the coding efficiency of the second encoding process can further be improved by performing the specific encoding distortion reduction process on the first decoded image. Examples of the specific encoding distortion reduction process include filtering using non local means, a bilateral filter, and an s-filter. For example, when the first encoding process is based on MPEG-2, the caused encoding distortion mainly includes a block noise and a ringing noise. In this case, the encoding distortion reduction processor 901 can reduce the encoding distortion by filtering using a deblocking filter, a deringing filter, and the like.

The encoding distortion reduction process in the present embodiment may switch between multiple means mentioned above or may switch between parameters for the means for each region. In this case, the switching may be based on a specific criterion, or information such as an index indicating the means set at the encoder side may be contained as additional data (encoding distortion reduction process information) in the extended data mentioned above.

In the present embodiment, the encoding distortion caused by the first encoding process is reduced by the encoding distortion reduction process at the encoding distortion reduction processor 901, which can further make the influence on the coding efficiency of the second encoding process smaller and thus further improve the coding efficiency of the second encoding process.

### Eight Embodiment

Next, an eighth embodiment will be described. In the eighth embodiment, a video decoding device associated with the video encoding device 900 according to the seventh embodiment described above will be described. Description of parts that are the same as those of the video decoding device 400 according to the second embodiment described above will not be repeated as appropriate.

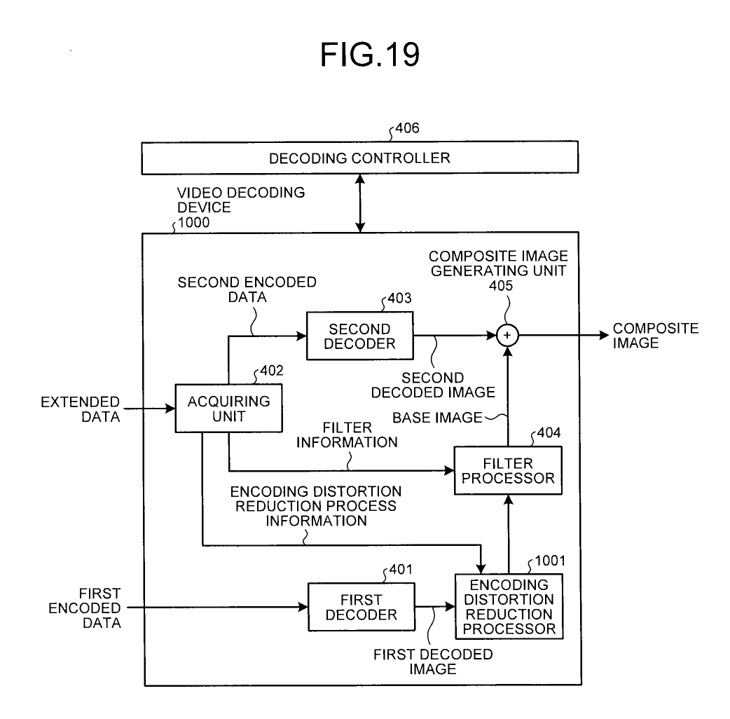

FIG. 19 is a block diagram illustrating the configuration of a video decoding device 1000 associated with the video encoding device 900 described above, and the decoding processor 406 that externally controls frame synchronization and the like of the video encoding device 900. As illustrated in FIG. 19, the video decoding device 1000 differs from the video decoding device 400 according to the second embodiment described above in further including an encoding distortion reduction processor 1001.

The encoding distortion reduction processor 1001 receives the base image from the filter processor 404, and performs a specific encoding distortion reduction process on the base image to generate an encoding distortion reduced image in which the encoding distortion caused by the first encoding process is reduced. The specific encoding distortion reduction process at the encoding distortion reduction processor 1001 is assumed to be the same as the encoding distortion reduction process performed by the encoding distortion reduction processor 901 of the video encoding device 900 according to the eighth embodiment described above. The above is the decoding method for the video decoding device 1000 according to the present embodiment.

### Ninth Embodiment

Next, a ninth embodiment will be described. A modification of the video encoding device 100 according to the first embodiment will be described here. Description of parts that are the same as those in the first embodiment described above will not be repeated as appropriate.

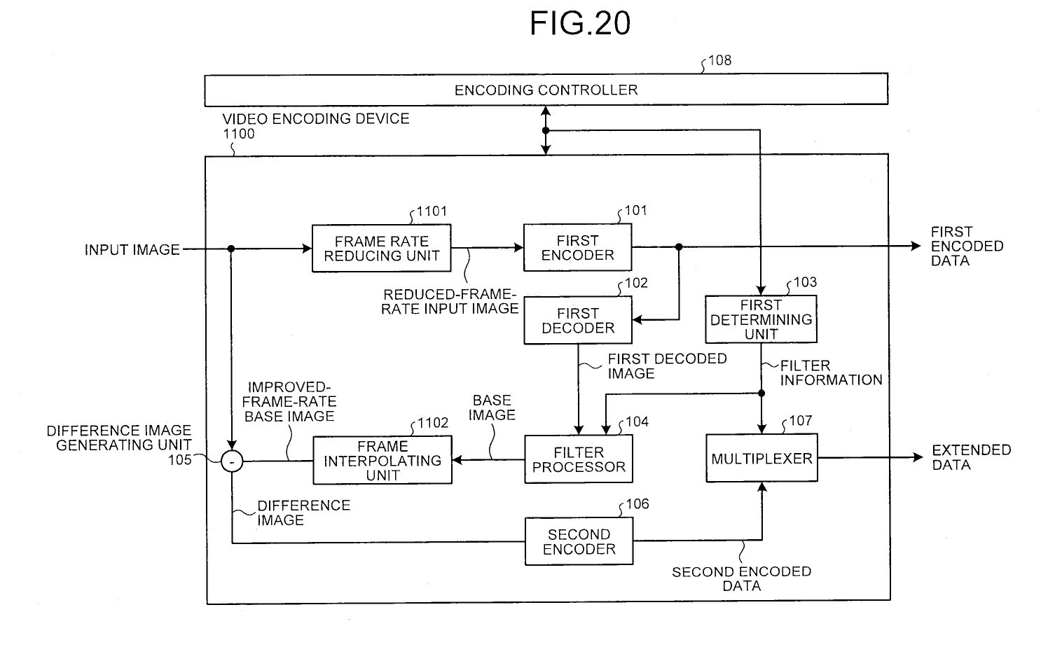

FIG. 20 is a block diagram illustrating the configuration of a video encoding device 1100 according to the present embodiment, and the encoding controller 108 that externally controls encoding parameters, frame synchronization, and the like of the video encoding device 1100. As illustrated in FIG. 20, the video encoding device 1100 differs from the video encoding device 100 according to the first embodiment described above in further including a frame rate reducing unit 1101 and a frame interpolating unit 1102.

The frame rate reducing unit 1101 receives the input image, and performs a specific frame rate reduction process on the input image to generate an image (“reduced-frame-rate input image”) with a frame rate lower than that of the input image. Any method can be used for the frame rate reduction process. For example, if the frame rate is to be halved, the halved frame rate may be achieved by simply thinning out frames or by adding blur depending on motion.

The base image generated by the filter processor 104 is output as an image with a lower frame rate than the input image as a result of the frame rate reduction process performed by the frame rate reducing unit 1101. The frame interpolating unit 1102 receives the base image from the filter processor 104, and performs a specific frame interpolation on the base image to generate an image (may be referred to as “increased-frame-rate base image” in the description below) with the same frame rate as the input image. In the present embodiment, the base image generated by the filter processor 104 is output as an image with a frame rate lower than that of the input image, but as a result of converting the image to the increased-frame-rate image with the same frame rate as the input image by the frame interpolating unit 1102 before generating a difference image between the increased-frame-rate base image and the input image by the difference image generating unit 105, the image quality of the composite image displayed by a receiver can be improved.

Any method can be used for the specific frame interpolation. For example, several frames before and after the frame to be interpolated may be referred to and interpolation may be performed by simple weighted addition, or motion may be detected and interpolation may be performed depending on the motion.

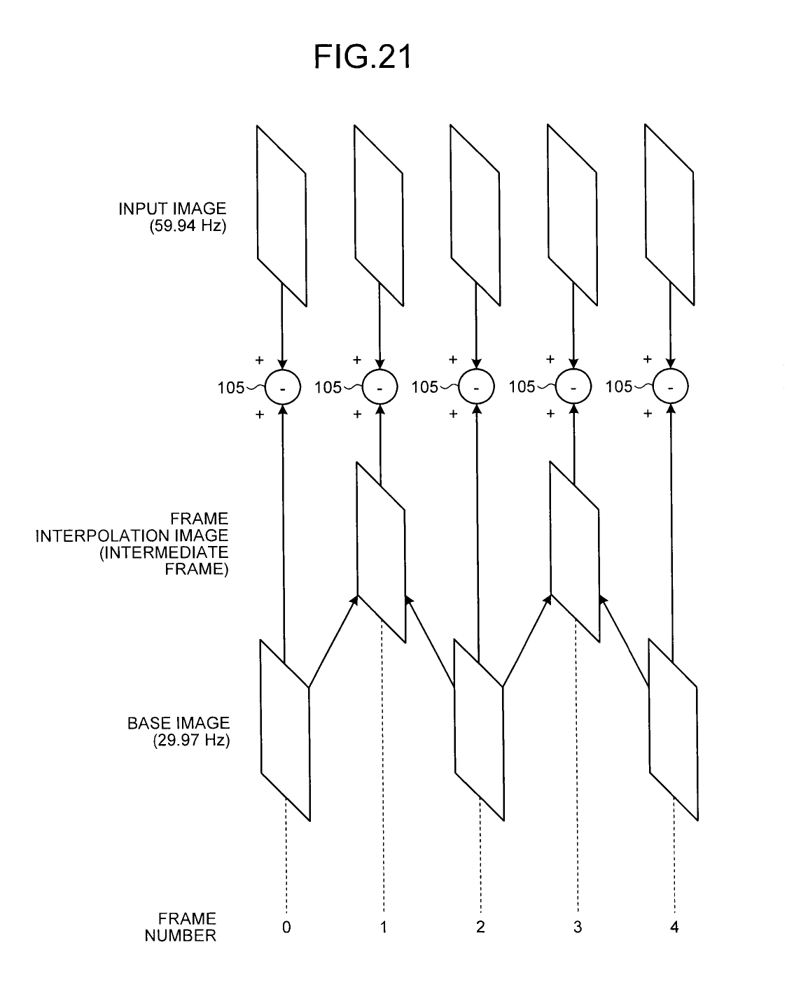

An example of frame interpolation in which motion information is analyzed based on successive frames and an intermediate frame is generated will be described with reference to FIG. 21. For example, if the first encoded data generated by the first encoder 101 is assumed to be broadcast using digital terrestrial broadcast, the frame rate of images input to the first encoder 101 is 29.97 Hz. In the example of FIG. 21, since the frame rate of the input image is 59.94 Hz, the frame rate reducing unit 1101 thins out odd-numbered frames to reduce the frame rate of the input image input to the first encoder 101 to 29.97 Hz. Thus, in the example of FIG. 21, only frames with the frame number 2n (n is an integer not smaller than 0) are input to the first encoder 101 and the frame rate of the base image generated by the filter processor 104 is also 29.97 Hz.

In this example, the frame interpolating unit 1102 analyzes motion information from successive frames of the input base image and generates a frame interpolated image (intermediate frame). As a result of the frame interpolation, frames with frame numbers 2n+1 (n is an integer not smaller than 0) are generated. Alternatively, the frame interpolating unit 1102 can also generate a frame interpolated image from successive frames of the first decoded image before being subjected to filtering by the filter processor 104, for example. In the example of FIG. 21, the difference image is generated by calculating the difference between the base image and the input image for the frames with the frame numbers 2n. Furthermore, the difference image is generated by calculating the difference between the frame interpolated image and the input image for the frames with the frame numbers 2n+1.

While only the image quality scalability can be achieved in the first embodiment described above, the temporal resolution scalability can be achieved by adding the frame rate reducing unit 1101 and the frame interpolating unit 1102 in the present embodiment.

### Tenth Embodiment

Next, a tenth embodiment will be described. In the tenth embodiment, a video decoding device associated with the video encoding device 1100 according to the ninth embodiment described above will be described. Description of parts that are the same as those of the video decoding device 400 according to the second embodiment described above will not be repeated as appropriate.

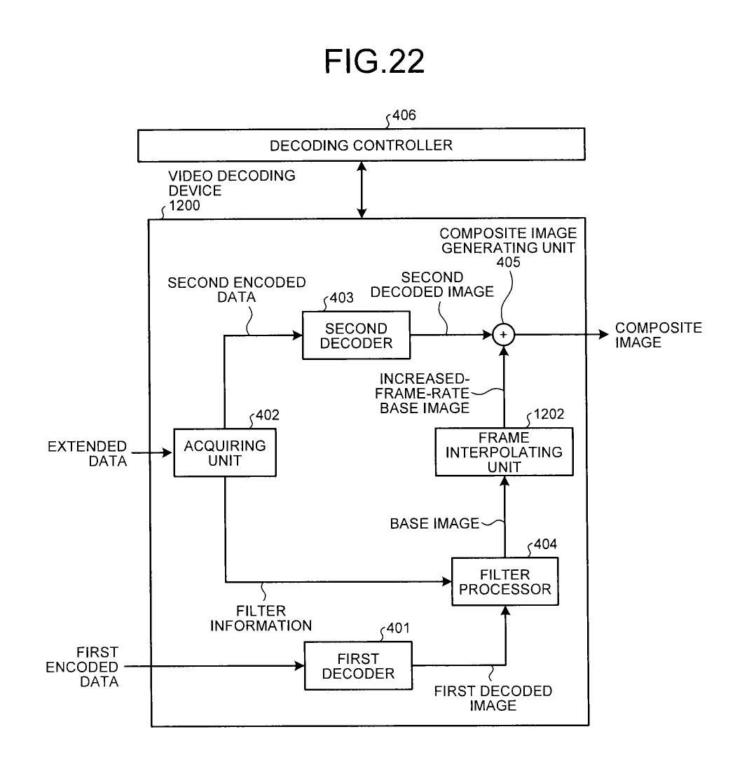

FIG. 22 is a block diagram illustrating the configuration of a video decoding device 1200 associated with the video encoding device 1100 described above, and the decoding processor 406 that externally controls frame synchronization and the like of the video encoding device 1100. As illustrated in FIG. 22, the video decoding device 1200 differs from the video decoding device 400 according to the second embodiment described above in further including a frame interpolating unit 1202.

The frame interpolating unit 1202 receives the base image from the filter processor 404, and performs a specific frame interpolation on the base image to generate a base image (increased-frame-rate base image) with the same frame rate as the second decoded image. The specific frame interpolation at the frame interpolating unit 1202 is assumed to be the same as the specific frame interpolation performed by the frame interpolating unit 1102 of the video encoding device 1100 according to the ninth embodiment described above. The above is the decoding method for the video decoding device 1200 according to the present embodiment.

### Eleventh Embodiment

Next, an eleventh embodiment will be described. A modification of the video encoding device 100 according to the first embodiment will be described here. Description of parts that are the same as those in the first embodiment described above will not be repeated as appropriate.

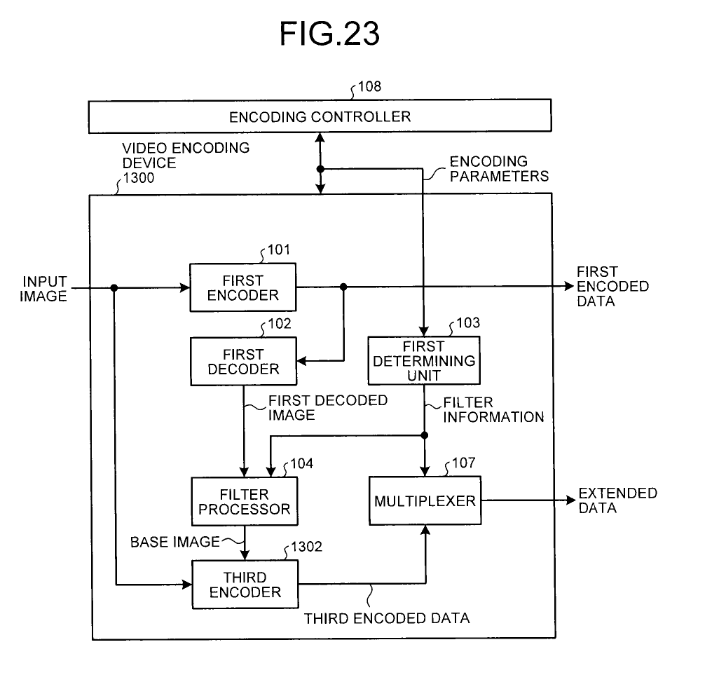

FIG. 23 is a block diagram illustrating the configuration of a video encoding device 1300 according to the present embodiment, and the encoding controller 108 that externally controls encoding parameters, frame synchronization, and the like of the video encoding device 1300. As illustrated in FIG. 23, the video encoding device 1300 differs from the video encoding device 100 according to the first embodiment described above in that the difference image generating unit 105 is not provided and that the second encoder 106 is replaced by a third encoder 1302.

Herein, the third encoder 1302 has functions of receiving as inputs the input image and the base image generated by applying filtering on the first decoded image, and performing predictive coding on the input image. Thus, the third encoder 1302 achieves scalable coding that uses the first encoder 101 as a base layer and encodes an enhanced layer.

For example, in MPEG-2, H.264 or the like, scalable coding techniques for the scalability with different image sizes, frame rates, and image qualities are introduced. The scalable coding is one of coding techniques capable of sequentially decoding multiplexed layers of encoded data from the lowermost layer to hierarchically restore video, and is also called hierarchical coding. Note that encoded data can be divided and used for each layer. For example, for the resolution scalability in H.264, video with a lower resolution is encoded at a base layer that is a low-level layer than an enhanced layer, the video with the low resolution is obtained when only this video is decoded, whereas video with a higher resolution can be obtained when encoded data at the enhanced layer that is a higher-level layer is also decoded. The enhanced layer performs predictive coding using enlarged video as a reference image after the base layer is decoded. As a result, the coding efficiency of the higher-level enhanced layer is increased. As a result of the scalable coding, the sum of bit rates when video at low resolutions is encoded and bit rates when video at high resolutions is encoded can be made smaller than encoding video with different resolutions independently of each other. For the image quality scalability, video at equal resolutions is assigned so that video with a low image quality is a base layer and video with a high image quality is assigned to an enhanced layer. Furthermore, for the temporal scalability, video at equal resolutions is assigned so that video with a low frame rate is a base layer and video with a high frame rate is assigned to an enhanced layer. Moreover, there are various scalabilities such as bit-length scalability for which input signals having lengths of 8 bits and 10 bits are hierarchically encoded, and color space scalability for which input signals of a YUV signal and an RGB signal are hierarchically encoded. Although scalable coding for achieving the image quality scalability is described herein, this can be easily applied to any of these scalabilities.

For example, as described in the third embodiment, the image reducing unit 501 and the image enlarging unit 502, for example, may be provided for the resolution scalability. Furthermore, as described in the ninth embodiment, the frame rate reducing unit 1101 and the frame interpolating unit 1102, for example, may be provided for the temporal scalability. For the bit length scalability, a bit length reducing unit and a bit length elongating unit may be provided. For the color space scalability, a YUV/RGB converter and an RGB/YUV converter may be provided. Note that these types of scalabilities can be used in combination. Although examples in which only one enhanced layer is used are presented herein, multiple enhanced layers can be used and different types of scalabilities can be applied to different layers.

Next, an encoding method of the video encoding device 1300 according to the present embodiment will be described. The functions of the first encoder 101, the first decoder 102, the first determining unit 103, and the filter processor 104 are the same as those of the video encoding device 100 according to the first embodiment described above. The base image output from the filter processor 104 is input to the third encoder 1302 together with the input image. The third encoder 1302 then performs predictive coding using the base image to generate third encoded data. More specifically, the predictive coding may be performed using the base image as one of reference images or may be used as one of texture predictions using the base image as a predicted image.

For example, for performing motion compensated prediction using the base image as one of reference images, the third encoder 1302 predicts the input image in units of pixel blocks (for example, blocks of 4 pixels×4 pixels or blocks of 8 pixels×8 pixels) by using a reference images, and calculates the difference between the reference image and the input image to generate a difference image (prediction residue). The third encoder 1302 can then generate third encoded data based on the generated difference image. Alternatively, for performing texture prediction, the third encoder 1302 calculates the difference between the input image and the base image to be used as a predicted image to generate a difference image (prediction residue). The third encoder 1302 can then generate third encoded data based on the generated difference image. In this example, the third encoder 1302 can be deemed to have a function of generating a difference image between an input image and a base image (corresponding to a “difference image generating unit” in the claims). Furthermore, in this example, the encoding process performed by the third encoder 1302 can be deemed to correspond to a “second encoding process” in the claims, and the third encoded data generated by the third encoder 1302 can be deemed to correspond to “second encoded data” in the claims.

Furthermore, in scalable coding in H.264, for example, texture prediction can be used as a possible prediction mode of pixel blocks. In this case, the base image positionally corresponding to a predicted pixel block is copied to the block to increase the prediction efficiency. In multi-view coding in H.264 (H.264/MVC), a framework capable of achieving inter-prediction coding using a base image for each pixel block is introduced by using video obtained by decoding disparity video (video in a base layer) different from an enhanced layer as one of reference images.

An extension of the texture prediction technique using a base image allows prediction by a combination of temporal motion compensated prediction and the base image. In this case, when the result of temporal motion compensated prediction is represented by MC and the base image is represented by BL, a predicted value of a pixel block can be calculated by the following equation (8). Motion compensated prediction is widely used in H.264, etc., and is a prediction technique for matching an encoded reference image and an image to be predicted for each pixel block and encoding a motion vector representing deviation in motion.

P=W×MC+(1−W)×BL (8).

In the equation (8), P represents a predicted value of the pixel block, and W is a weighting factor indicating the proportion of each of the motion compensated prediction result and the base image. W is a value from 0 to 1MC refers to a predicted value of the motion compensated prediction generated by conventional inter-prediction coding that does not use scalable coding. As a result of combining the predicted value of temporal motion compensated prediction and the spatial predicted value of texture prediction, improvement in the coding efficiency can be expected. Note that it is also possible to set W to be an integer so that the prediction formula will be of integer values and calculated in fixed-point precision. For example, for a fixed-point calculation in 8 bits, a value obtained by multiplying a real value W by 256 is used. Division by 256 after the calculation based on the equation (8) allows operation of the weighting factor in 8-bit precision.

Furthermore, motion compensated prediction can be introduced to texture prediction. In this case, a predicted image is generated by the following equation (9) using an encoded reference image BLMC temporally different from a picture to be encoded:

P=W×(MC−BLMC)+(1−W)×BL (9)

The same motion vector is used for the motion vector for motion compensated prediction by conventional inter-prediction coding that does not use scalable coding and the motion vector of the base image (reference image) BLMC temporally different from the picture to be encoded. As a result, the coding efficiency can further be higher than the equation (8) without increasing the code amount of the motion vector to be encoded.

The third encoded data generated by scalable coding at the third encoder 1302 is input to the multiplexer 107. The multiplexer 107 multiplexes the filter information and the third encoded data that are input thereto into a specific data format, and outputs the result as extended data to outside of the video encoding device 1300. Note that the first encoded data and the extended data may further be multiplexed. Data output from the video encoding device 1300 is transmitted over various transmission paths, which are not illustrated, or stored in an external storage or memory such as a DVD and an HDD and output therefrom. Examples of possible transmission paths include a satellite channel, a digital terrestrial broadcast channel, an Internet connection, a radio channel, and a removable medium.

In scalable coding, if the encoding distortion is superimposed on the first decoded image obtained by encoding and decoding at a base layer, video on which the encoding distortion is superimposed is used as a predicted image in encoding at the third encoder 1302, and thus the encoding distortion is also a main factor of a decrease in the coding efficiency. In view of the above, the first determining unit 103 and the filter processor 104 are introduced to cut off the frequency components containing the encoding distortion by specific band-limiting filtering. More specifically, as a result of performing band-limiting filtering in a specific frequency band on the base image before being used for predictive coding, the encoding distortion caused by the first encoding process can be removed, the spatial correlation and the temporal correlation of the difference image can be improved, and the coding efficiency of the third encoding process can be improved.

The specific cutoff frequency can be determined similarly to the embodiments described above, but a cutoff frequency optimal for each pixel block can be determined since the encoding process progresses sequentially in units of pixel block in scalable coding, which can further improve the coding efficiency of the third encoding process. In this case, information indicating the cutoff frequency for each pixel block needs to be contained in the third encoded data.

Note that the configuration of the video encoding device 1300 according to the present embodiment may additionally include the image reducing unit 501 and the image enlarging unit 502 described above in the third embodiment to achieve resolution scalability. Furthermore, the configuration may additionally include the interlaced converter 701 and the progressive converter 702 described above in the fifth embodiment to achieve temporal scalability. Moreover, the encoding distortion reduction processor 901 described above in the seventh embodiment may be introduced so that the block distortion specific to the first encoding process can be reduced.

Furthermore, in the present embodiment, the first encoder 101 and the third encoder 1302 may have different encoding methods. For example, the first encoding process performed by the first encoder 101 may be an encoding process based on MPEG-2 whereas the third encoding process performed by the third encoder 1302 may be an encoding process based on HEVC. MPEG-2 is used in various video formats including digital terrestrial broadcast and storage media such as a DVD. MPEG-3 has, however, a lower encoding performance (lower coding efficiency) than H.264 and HEVC. In scalable coding, a configuration in which a base layer employs MPEG-2 and an enhanced layer employs HEVC or the like can provide video that can be reproduced in a conventional manner with a conventional product, and with additional values such as a higher image quality, a higher resolution, and a higher frame rate with a product supporting new formats. A configuration placing emphasis on such backward compatibility can also be provided.

Furthermore, an example in which extended data obtained by multiplexing the filter information and the third encoded data is transmitted is presented in the present embodiment. As a result of transmitting the first encoded data and the extended data over different transmission networks, extension of systems is possible without changing the existing band for transmitting the first encoded data. For example, transmitting the first encoded data over a transmission band used for digital terrestrial broadcast and the extended data over the Internet or the like allows easy extension of a system without changing the existing system. Furthermore, the first encoded data and the extended data may further be multiplexed and transmitted over the same transmission network. In this case, video of the base layer can be decoded by decrypting the multiplexed data and decoding only the first encoded data. If the extended data is also decoded, video of the enhanced layer can also be decoded. In this case, information on the enhanced layer may be described in a manner that does not affect the existing system decoding bit streams of the base layer as described in Annex.G of H.264.

### Twelfth Embodiment

Next, a twelfth embodiment will be described. In the twelfth embodiment, a video decoding device associated with the video encoding device 1300 according to the eleventh embodiment described above will be described. Description of parts that are the same as those of the video decoding device 400 according to the second embodiment described above will not be repeated as appropriate.

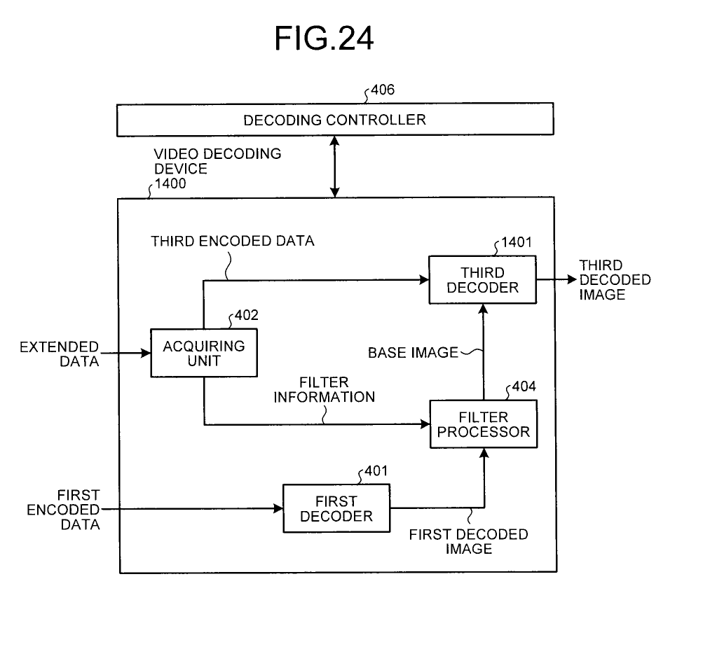

FIG. 24 is a block diagram illustrating the configuration of a video decoding device 1400 associated with the video encoding device 1300 described above, and the decoding processor 406 that externally controls frame synchronization and the like of the video encoding device 1300. As illustrated in FIG. 24, the video decoding device 1400 differs from the video decoding device 400 according to the second embodiment described above in that the composite image generating unit 405 is not provided and that a third decoder 1401 associated with the third encoder 1302 described above is provided in place of the second decoder 403.

Herein, the third decoder 1401 has functions of receiving as inputs the third encoded data obtained by the separation by the acquiring unit 402 and the base image generated by the filter processor 404, and performing predictive decoding on the third encoded data. Thus, the third decoder 1401 achieves scalable decoding that uses the first decoded image decoded by the first decoder 401 as a base layer and decodes an enhanced layer.

Next, a decoding method of the video decoding device 1400 according to the present embodiment will be described. The functions of the first decoder 401, the acquiring unit 402, and the filter processor 404 are basically the same as those of the video decoding device 400 according to the second embodiment described above. In the following description, functions of the third decoder 1401 that are not included in the video decoding device 400 according to the second embodiment will be mainly described.

The base image output from the filter processor 404 is input to the third decoder 1401 together with the third encoded data. The third decoder 1401 then performs a predictive decoding process using the base image to generate a third decoded image. More specifically, the third decoder 1401 may perform the predictive decoding using the base image as one of reference images or may use the predictive decoding as one of texture predictions using the base image as a predicted image. As mentioned above, in scalable coding in H.264, for example, texture prediction can be used as a possible prediction mode of pixel blocks. An extension of the texture prediction technique using a base image allows prediction by a combination of temporal motion compensated prediction and the base image as expressed by the equation (8). Furthermore, motion compensated prediction can be introduced to texture prediction as expressed by the equation (9).

If the encoding distortion is superimposed on the first decoded image obtained by encoding and decoding at a base layer, video on which the encoding distortion is superimposed is used as a predicted image in decoding at the third decoder 1401, and thus the encoding distortion is a main factor of a decrease in the decoding efficiency. In view of the above, the filter processor 404 is introduced to remove the encoding distortion by band-limiting filtering of a specific frequency band. More specifically, by performing specific band-limiting filtering on the first decoded image before being used for predictive decoding, the encoding distortion can be removed, the spatial correlation and the temporal correlation of the difference image can be improved, and the decoding efficiency of the third decoding process can be improved.

Note that the configuration of the video decoding device 1400 according to the present embodiment may additionally include the image enlarging unit 602 described above in the fourth embodiment to achieve resolution scalability. Furthermore, the configuration may additionally include the progressive converter 802 described above in the sixth embodiment to achieve temporal scalability. Moreover, the encoding distortion reduction processor 1001 described above in the eighth embodiment may be introduced so that the block distortion specific to the first encoding process can be reduced.

Furthermore, the decoding method of the first decoder 102 and that of the third decoder 1401 may be different from each other. For example, the first decoder 102 may perform a decoding process based on MPEG-2 whereas the third decoder 1401 may perform a decoding process based on HEVC.

The above is the decoding method for the video decoding device 1400 according to the present embodiment.

For example, although exemplified devices and methods that encode videos in the embodiments are described above, the present application is not limited thereto and can also be applied to devices and methods that encode still images. Furthermore, although exemplified devices and methods that decode videos in the embodiments are described above, the present application is not limited thereto and can also be applied to devices and methods that decode still images.

The video encoding device according to the embodiments described above includes a CPU, a storage device such as a read only memory (ROM) and a random access memory (RAM), an external storage device such as an HDD and a CD drive, a display device such as a display, and an input device such as a key board and a mouse, which is a hardware configuration utilizing a common computer system. Furthermore, the functions of the respective components (the first encoder 101, the first decoder 102, the first determining unit 103, the filter processor 104, the difference image generating unit 105, the second encoder 106, the multiplexer 107, the image reducing unit 501, the image enlarging unit 502, the interlaced converter 701, the progressive converter 702, the encoding distortion reduction processor 901, the frame rate reducing unit 1101, the frame interpolating unit 1102, and the third encoder 1302) of the video encoding device according to the embodiments described above are realized by executing programs stored in the storage device by the CPU. Alternatively, for example, at least some of the functions of the respective components of the video encoding device according to the embodiments described above may be realized by hardware circuits (such as semiconductor integrated circuits).

Similarly, the video decoding device according to the embodiments described above includes a CPU, a storage device such as a read only memory (ROM) and a random access memory (RAM), an external storage device such as an HDD and a CD drive, a display device such as a display, and an input device such as a key board and a mouse, which is a hardware configuration utilizing a common computer system. Furthermore, the functions of the respective components (the first decoder 401, the acquiring unit 402, the second decoder 403, the filter processor 544, the composite image generating unit 405, the image enlarging unit 602, the progressive converter 802, the encoding distortion reduction processor 1001, the frame interpolating unit 1202, and the third decoder 1401) of the video decoding device according to the embodiments described above are realized by executing a program stored in the storage device by the CPU. Alternatively, for example, at least some of the functions of the respective components of the video decoding device according to the embodiments described above may be realized by hardware circuits (such as semiconductor integrated circuits).

The programs to be executed by the video encoding device and the video decoding device according to the embodiments described above may be stored on a computer system connected to a network such as the Internet, and provided by being downloaded via the network. Alternatively, the programs to be executed by the video encoding device and the video decoding device according to the embodiments described above may be provided or distributed through a network such as the Internet. Still alternatively, the programs to be executed by the video encoding device and the video decoding device according to the embodiments described above may be embedded in a nonvolatile storage medium such as a ROM and provided therefrom.

While certain embodiments have been described, these embodiments have been presented by way of example only, and are not intended to limit the scope of the present application. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An encoding device comprising:
a first encoder to encode an input image by a first encoding process to obtain first encoded data;
a filter processor to filter a first decoded image by cutting off a specific frequency band of frequency components to obtain a base image, the first decoded image included in the first encoded data;
a difference image generating unit to generate a difference image between the input image and the base image; and
a second encoder to encode the difference image by a second encoding process to obtain second encoded data,
wherein the second encoding process is a process for encoding the difference image to obtain the second encoded data.

2. The encoding device according to claim 1, wherein the filter processor passes the frequency components of the first decoded image with frequencies lower than a cutoff frequency.

3. The encoding device according to claim 2, further comprising a first determining unit to determine the cutoff frequency depending on a bit rate of the second encoded data.

4. The encoding device according to claim 3, wherein
relation between the cutoff frequency and image quality information indicating objective image quality of a second decoded image obtained by decoding the second encoded data at each bit rate is expressed by a parabola having a maximum point, and
the first determining unit includes:
a storage unit to store therein relation information indicating relation between the bit rate and a maximum cutoff frequency representing the cutoff frequency corresponding to the maximum point; and
a second determining unit to identify the maximum cutoff frequency associated with the specified bit rate by using the relation information and determine the identified maximum cutoff frequency as the cutoff frequency to be used for the filtering.

5. The encoding device according to claim 4, wherein
the first determining unit further includes an estimating unit to estimate encoding distortion caused by the first encoding process on a basis of at least one of the input image, the first encoded data, and the first decoded image,
the storage unit stores therein the relation information varying depending on the encoding distortion, and
the second determining unit identifies the maximum cutoff frequency associated with a specified bit rate by using the relation information associated with the encoding distortion estimated by the estimating unit, and determines the identified maximum cutoff frequency as the cutoff frequency to be used for the filtering.

6. The encoding device according to claim 5, wherein the relation information indicates that the maximum cutoff frequency associated with a specific bit rate is lower as the encoding distortion is larger.

7. The encoding device according to claim 1, further comprising:
an image reducing unit to reduce resolution of the input image before the first encoded data is obtained; and
an image enlarging unit to increase resolution of the base image before the difference image is obtained.

8. The encoding device according to claim 1, wherein the second encoding process is higher in coding efficiency than the first encoding process.

9. An encoding method comprising:
encoding an input image by a first encoding process to obtain first encoded data;
filtering a first decoded image by cutting off a specific frequency band of frequency components to obtain a base image, the first decoded image included in the first encoded data;
generating a difference image between the input image and the base image; and
encoding the difference image by a second encoding process to obtain second encoded data.

10. A decoding device comprising:
a first decoder to decode first encoded data by a first decoding process to obtain a first decoded image, the first encoded data being obtained by encoding an input image by a first encoding process;
an acquiring unit to receive, from outside, extended data containing second encoded data and filter information, the second encoded data being obtained by encoding a difference image by a second encoding process, the difference image being an image between the input image and a base image, the base image being obtained by filtering the first decoded image by cutting off a specific frequency band of frequency components, and the filter information indicating the specific frequency band;
a second decoder to decode the second encoded data contained in the extended data by a second decoding process to obtain a second decoded image;
a filter processor to filter the first decoded image by cutting off the specific frequency band indicated by the filter information contained in the extended data out of the frequency components of the first decoded image obtained by the first decoder to obtain the base image; and
a composite image generating unit to generate a composite image based on the base image obtained by the filter processor and based on the second decoded image.

11. The decoding device according to claim 10, wherein the filter processor passes the frequency components of the first decoded image with frequencies lower than a cutoff frequency.

12. The decoding device according to claim 11, wherein
the filter information indicates the cutoff frequency, and
the cutoff frequency indicated by the filter information is determined depending on a bit rate of the second encoded data.

13. The decoding device according to claim 12, wherein
relation between the cutoff frequency and image quality information indicating objective image quality of the second decoded image at each bit rate is expressed by a parabola having a maximum point, and
the cutoff frequency indicated by the filter information is a maximum cutoff frequency associated with a specified bit rate determined by using relation information indicating relation between the bit rate and the maximum cutoff frequency representing the cutoff frequency corresponding to the maximum point.

14. The decoding device according to claim 13, wherein
the relation information varies depending on encoding distortion caused by the first encoding process,
the cutoff frequency indicated by the filter information is the maximum cutoff frequency associated with the specified bit rate determined by using the relation information associated with the encoding distortion estimated on a basis of at least one of the input image, the first encoded data, and the first decoded image.

15. The decoding device according to claim 14, wherein the relation information indicates that the maximum cutoff frequency associated with a specific bit rate is lower as the encoding distortion is larger.

16. The decoding device according to claim 10, wherein the second encoding process is higher in coding efficiency than the first encoding process.

17. The decoding device according to claim 10, wherein
the first encoded data is obtained by performing the first encoding process on the input image on which a process of reducing resolution is performed,
the second encoded data is obtained by performing the second encoding process on a difference image between the base image with increased resolution and the input image, and
the decoding device further comprises an image enlarging unit to increase resolution of the base image obtained by the filter processor.

18. A decoding method comprising:
decoding first encoded data by a first decoding process to obtain a first decoded image, the first encoded data being obtained by encoding an input image by a first encoding process;
receiving, from outside, extended data containing second encoded data and filter information, the second encoded data being obtained by encoding a difference image by a second encoding process, the difference image being an image between the input image and a base image, the base image being obtained by filtering the first decoded image by cutting off a specific frequency band of frequency components, and the filter information indicating the specific frequency band;
decoding the second encoded data contained in the extended data by a second decoding process to obtain a second decoded image;
filtering the first decoded image by cutting off the specific frequency band indicated by the filter information contained in the extended data out of the frequency components of the first decoded image obtained in the first decoding process to obtain the base image; and
generating a composite image based on the base image obtained by the filtering and based on the second decoded image.
